(19) United States
(12) Patent Application Publication
(10) Pub. No.: US 2012/0085951 A1
(43) Pub. Date: Apr. 12, 2012

(54) ROTARY PLUG, BALL, AND LABORATORY STOPCOCK VALVES WITH ARBITRARY MAPPING OF FLOW TO ROTATION ANGLE AND PROVISIONS FOR SERVO CONTROLS

(76) Inventor: Lester F. LUDWIG, Belomont, CA (US)

(21) Appl. No.: 12/899,551

(22) Filed: Oct. 7, 2010

(51) Int. Cl. F16K 31/02

(52) U.S. Cl. 251/129.04

(57) ABSTRACT

A system for extending the adjustment range and flow control precision of the flow of materials in a rotary valve is described. The system includes a valve body, an input and an output port penetrating the valve body and providing couplable means to the outside of the valve body, a rotating member deposed in the valve body, and motor or servo connected to the rotating member. The rotating member has two elongated openings, the longer dimensions of the openings are aligned circumferentially and positioned so that they are diagonally opposite of each other on the circumference. A passageway through the rotating member connects the two elongated openings. A motor is coupled to the rotating member and controls the angular rotation within a first range of angular positions overlapping, at least in part, the two ports, and within a second range of angular positions wherein the two elongated opening so not overlap the two ports.

### CROSS-REFERENCE TO RELATED APPLICATIONS

This application claims benefit of priority of U.S. provisional application Ser. No. 61/249,047 filed on Oct. 6, 2009, incorporated herein by reference.

### BACKGROUND OF THE INVENTION

1. Field of the Invention

This invention relates to rotary valves, and in particular to the design of the passageway within the internal rotating element of a plug or ball valve so that the cross-sectional area and resultant flow rate can be varied in a desired mathematical relationship (linear, quadratic, exponential, log, etc.) with the angle of rotation, and in a way wherein under controlled conditions turbulence can be accounted for. A resulting rotary plug valve approach can be used in remote control and laboratory automation applications involving conventional chemical glassware.

2. Background of the Invention

A plug valve contains a solid cylindrical or slightly-conical plug or “barrel” that can be rotated inside the valve to control flow through the valve. Usually the cylindrical or slightly-conical plug in a plug valve has one or more hollow passage ways going through the plug, so that fluid, gas, slurries, or other substances can flow through the plug passage way when the valve is open. Most of laboratory stopcock valves implement above mentioned types of valves and are used as parts of burettes, separatory funnels, and other fluid and gas pathways.

Similarly, a ball valve has a solid spherical ball inside the valve that has a hollow volume, or cavity. A handle is attached to the ball inside the valve, so the valve is opened to control flow through the valve as the handle is turned. These valves are often simple and economical way of flow control.

### SUMMARY OF THE INVENTION

The invention relates to a system for extending the adjustment range and flow control precision of the flow of materials in a rotary valve. The system comprises a hollow valve body, at least one input port and one output port penetrating the valve body and providing couplable means to the outside of the valve body, a rotating member deposed in and in contact with the internal surface of the chamber and the ports, and a motor or servo connected to the rotating member.

The rotating member has two elongated openings located on the surface of the rotating member. The longer dimensions of each of the two elongated openings are aligned on a circumference of the rotating member and positioned so that they are diagonally opposite of each other on the circumference.

A passageway through the rotating member connects the two elongated openings thereby permitting a flow through the rotating member.

A motor is coupled to the rotating member for rotating the rotating member, and controls an angular position of the rotating member to position the two elongated openings of the rotating member within a first range of angular positions overlapping, at least in part, the two ports, and within a second range of angular positions wherein the two elongated opening so not overlap the two ports.

The system permits a flow of materials between the input port and the output port when the rotating member is positioned within the first range of angular positions and prevents a flow of materials between the ports when the rotating member is positioned within the second range of angular positions.

The rotating member maybe a sphere, a conical plug, or a cylindrical plug. The valve body and the rotating plug for laboratory stopcock, and maybe made of glass.

The motor maybe controlled by a computer using laboratory automation software, and angular position feedback of the rotating member may be measured by a sensor

### BRIEF DESCRIPTION OF THE DRAWINGS

The invention will be described in greater detail below with reference to the accompanying drawings. The above and other aspects, features and advantages of the present invention will become more apparent upon consideration of the following description of preferred embodiments taken in conjunction with the accompanying drawing figures. The accompanying figures are examples of the various aspects and features of the present invention and are not limiting either individually or in combination.

FIGS. 1a-1h depict exemplary structure, components, and operation of a conventional plug-type rotary “stopcock” valve traditionally employed in laboratory glassware.

FIGS. 2a and 2b illustrates an conventional ball-type rotary valve, respectively in representative open and closed positions, in particular of a style commonly used in facilities and industry.

FIGS. 3a-3b depict a first structure, components, and operation of a conventional plug-type rotary “stopcock” valve traditionally employed in laboratory glassware wherein a third inlet/outlet tube is provided.

FIGS. 4a-4c depict a second structure, components, and operation of a conventional plug-type rotary “stopcock” valve traditionally employed in laboratory glassware wherein a third inlet/outlet tube is provided.

FIGS. 5a-5j depict a third structure, components, and operation of a conventional plug-type rotary “stopcock” valve traditionally employed in laboratory glassware wherein a third inlet/outlet tube is provided.

FIG. 6a depicts a plug of a conventional rotary plug valve showing a circularly-cylindrical hollow passageway through the plug.

FIG. 6b depicts the arrangement of FIG. 4a rotated by 90 degrees.

FIG. 7 shows flow responses as a function of actuator rotation angle for a conventional plug or ball valve; these response curves may be realized by varied choices of cams, passageway shape, viscosity effects, turbulence effects, etc.

FIGS. 8a-8c depict an exemplary modified plug element provided for by the invention comprising an elongated opening on diametric sides of the plug connected by a hollow passageway through the plug.

FIG. 9a shows a modified plug element of the invention comprising an elongated hollow passageway through the plug with cross-sectional area that varies monotonically with the rotational angle for at least a portion of the permitted rotation.

FIG. 9b shows the arrangement of FIG. 5b rotated by 90 degrees.

FIG. 9c illustrates the range of shapes of the exposed portion of the passageway as seen through the aperture of the modified valve of FIGS. 5b and 5c, the shapes vary with the angular position of the rotating element within the valve.

FIGS. 9d and 9e depict a ball valve rotating element comprising a circular passageway.

FIGS. 9f through 9h depict the modified ball element of FIGS. 5b and 5c comprising an elongated hollow passageway through the ball with cross-sectional area that varies monotonically with the rotational angle for at least a portion of the permitted rotation.

FIG. 9i depicts the modified rotating ball element of FIGS. 5g through 5i as of the invention, additionally labeled considering projection effects on the aperture view of the passageway.

FIG. 10a illustrates aperture and rotation axis points of view that are used in describing the invention.

FIG. 10b employs one of the views depicted in FIG. 5d to define angles used in descriptions of the invention.

FIGS. 11a and 11b show relationships between variables defined between polar and rectangular coordinate systems used in calculations and descriptions of aspects of the invention.

FIGS. 12a-12c shows three segments of the passageway as seen through the aperture used for a larger area calculation.

FIG. 13a illustrates three segments of the passageway, illustrated in FIGS. 12a-12c, combined comprise an area equivalent to either the top half or bottom half of the exposed area of the passageway.

FIG. 13b illustrates how doubling the area illustrated in FIG. 9a will be equivalent to the entire exposed area of the passageway.

FIG. 14a-14c illustrate an alternative approach to FIGS. 12a-12c useful for area calculations for the exposed area of the passageway.

FIG. 15a shows the geometric projection transformation of a linear rule laid out over the arc length of a rotary element into the geometry as seen from the aperture view point.

FIG. 15b illustrates the aperture radius Rₐ and plug radius Rₚ in terms of the stopcock example depicted in FIGS. 1a, 1b, and 10a.

FIG. 15c illustrates the sector of the plug of FIG. 11b that is exposed within the aperture of radius Rₐ.

FIG. 15d illustrates the relationship between circumferential arc length and the projection length.

FIG. 16 illustrates how a hole that is cut out along a template generates different shapes in projected view depending on whether the template is applied on a flat surface or on a curved surface.

FIGS. 17a-17c illustrate views from the side of the stopcock valve as the angle of the handle varies.

FIGS. 18a-18c illustrate views from the top of the stopcock valve, for a curved-taper opening, as the angle of the handle varies, each respectively corresponding to the handle positions depicted in FIGS. 13a-13c.

FIGS. 19a and 19b illustrate, respectively, cases when the rotary valve is completely opened and completely closed, useful in determining maximum span of the passageway through the rotary element.

FIG. 19c illustrates an aperture viewpoint for an exemplary case of a partially-open rotary valve in accordance with the invention wherein the curve defining the opening is given by the function f(x).

FIG. 20 depicts several approaches to solving the geometric and mathematical problems associated with aspects of the invention.

FIG. 21 depicts discrete step-size variation as a function of rotation projected onto the aperture view (and hence flow path), the variation resulting from sine-function mapping induced by the projection from the curved surface.

FIG. 22 depicts the geometry and measurements of the two discrete steps either side of the aperture center.

FIG. 23 shows another representation of discrete step-size variation as a function of rotation projected onto the aperture view (and hence flow path), the variation resulting from sine-function mapping induced by the projection from the curved surface.

FIG. 24 depicts a passageway opening shape having uniform step sizes. Similar types of geometries result from non-uniform step sizes.

FIG. 25 depicts another opening shape having uniform step sizes. Similar types of geometries result from non-uniform step sizes.

FIGS. 26a and 26b depicts a trapezoid comprised by geometric arrangements such as that depicted in FIGS. 24 and 25.

FIG. 27 is vector and matrix equation that can be formulated from a collection of trapezoids such as those of FIG. 26 that are in turn comprised by geometric arrangements such as that depicted in FIGS. 16 and 17.

FIG. 28 illustrates the generic situation where a stopcock can be coupled with a servo motor, stepper motor, or other angular actuator.

FIG. 29a illustrates a transverse direct linkage between a traditional stopcock handle and a servo motor, stepper motor, or other angular actuator.

FIG. 29b illustrates a view of a mounting arrangement for the configuration of FIG. 29a.

FIG. 29c illustrates a 90-degree side view of the mounting arrangement shown in FIG. 29b.

FIG. 30a illustrates that a stopcock can be coupled with a servo motor, stepper motor, or other angular actuator using a geared arrangement.

FIG. 30b illustrates a geared linkage between a conventional stopcock handle and a servo motor, stepper motor, or other angular actuator.

FIG. 30c illustrates a mounting arrangement for the configuration of FIG. 30b.

FIG. 31a illustrates a direct linkage between the stopcock and a servo motor, stepper motor, or other angular actuator with an off-center drive shaft, along with a mounting arrangement.

FIG. 31b illustrates a direct linkage between the stopcock and a servo motor, stepper motor, or other angular actuator with a centered drive shaft, along with a mounting arrangement.

FIGS. 32a-32g depict an example implementation wherein a stopcock plug internally comprises a movable element that can be controlled by a servo or motor element.

FIG. 33a depicts a front view of an epicyclic (“planetary”) gear arrangement. FIG. 33b depicts a size view of an epicyclic gear arrangement. FIG. 33c depicts an exploded view of an epicyclic gear arrangement. FIG. 33d depicts an example implementation wherein the electrical motor attachment depicted in FIG. 32d internally comprises at least one epicyclic gear arrangement.

FIGS. 34a-34b illustrate a second type of stopcock flow adjustment wherein a stopcock plug internally comprises a longitudinally-movable gating element.

FIGS. 35a-35b depict the arrangements of FIGS. 34a-34b placed into a stopcock body.

FIGS. 36a-36b depict a traditional laboratory glassware stopcock arrangement outfitted with servo or motor control arrangements.

FIGS. 37a-37c depict an exemplary laboratory glassware configuration and its adaptation to utilize four motorized rotary valves so as to support laboratory automation.

### DETAILED DESCRIPTION

In the following descriptions, reference is made to the accompanying drawing figures which form a part hereof, and which show by way of illustration specific embodiments of the invention. It will be understood by those of ordinary skill in this technological field that other embodiments may be utilized, and structural, electrical, as well as procedural changes may be made without departing from the scope of the present invention.

Furthermore, in the figures, it is to be understood that a significant emphasis has been placed on depicting functionality, structure, and methods regarding many aspects of the invention. In choosing this emphasis, little treatment of aesthetics and visual appeal has been included. It is to be understood that a number of additional techniques of encasement, overlay bezel, alternate structure, ornamental embellishment, etc. can be used to obtain a wide range of aesthetic value and effect.

### Review of Traditional Laboratory Glassware Stopcock Technologies

One of the elements to be adapted would be laboratory glassware apparatus stopcocks. This section provides various approaches to providing servo-controlled adaptors for traditional laboratory glassware apparatus stopcocks.

Most stopcocks offer only limited control of flow rates beyond simple on/off operation. Elongating the passageway opening along the surface and through the stopcock plug into a teardrop shape can increase the usable rotation angle so as to provide the user or a servo system get finer degrees of accuracy in adjustment. In other words a usable rotation angle of rotation would result in a more detailed adjustable flow rate. This has value in both servo-based operation and in hand-based operation. The invention provides for various approaches to elongating the passageway opening in the stopcock plug and employing various tapered passageway shape, for example a teardrop shape. In the case of Teflon stopcock plugs it is noted that that the near-surface portions of an existing passageway hole in the plug can be carved into an elongated cavity through use of a milling machine.

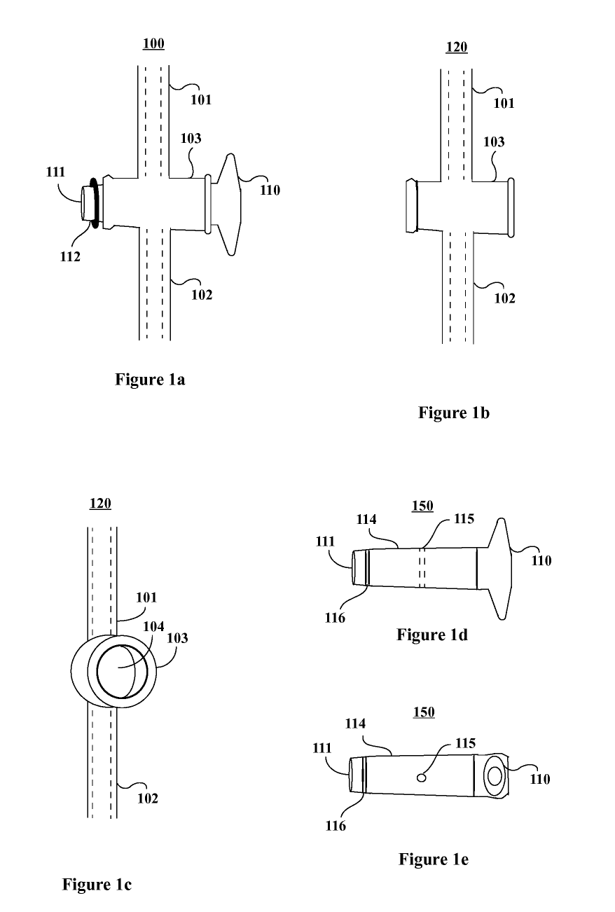

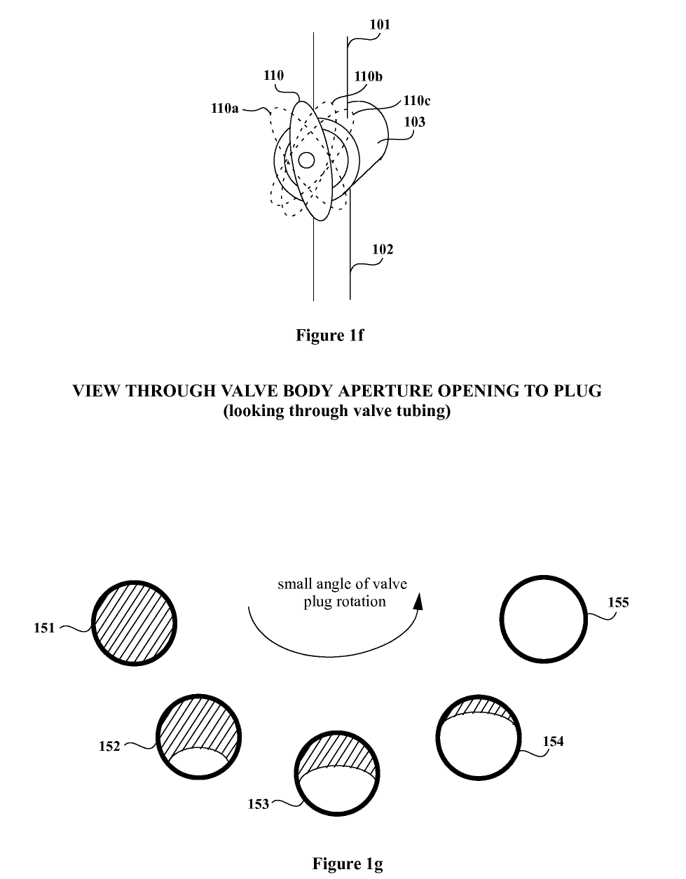

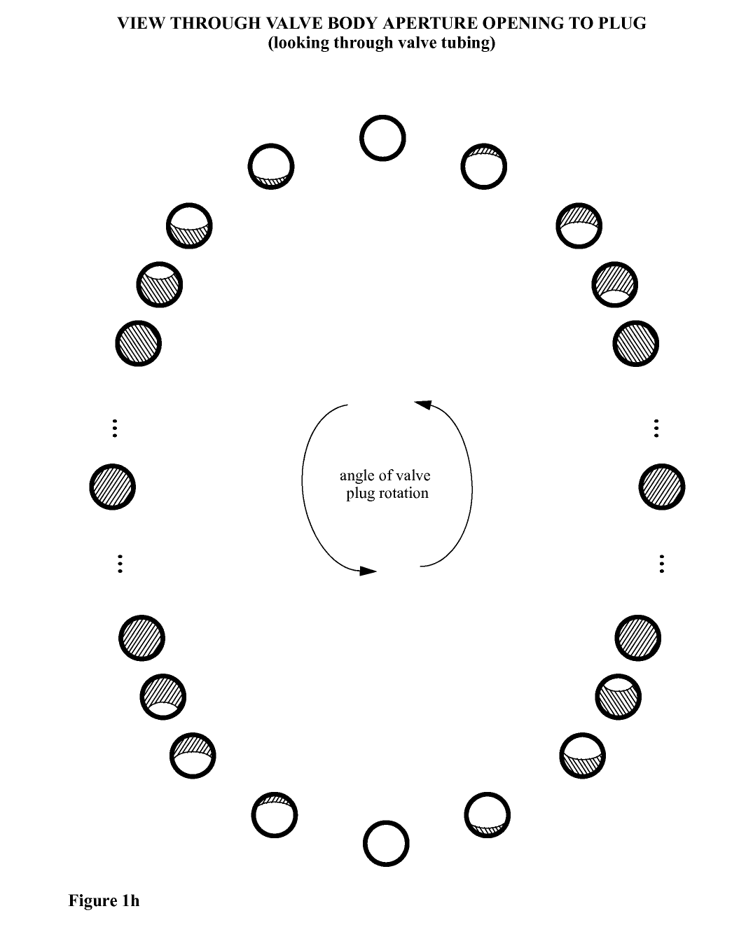

FIGS. 1a-1h depict structure, components, and operation of a conventional plug-type rotary “stopcock” valve traditionally employed in laboratory glassware. Many other types of embodiments exist as is appreciated by one skilled in the art. The conventional lab glassware stopcock depicted in FIG. 1a comprises at least two inflow/outflow tubes 101, 102, and a valve body 103, all typically made of high-performance glass. This portion of the arrangement of FIG. 1a is depicted in two viewing perspectives in FIGS. 1b an 1c. The conventional lab glassware valve body 103 provides an outer encasement and is internally configured with a cylindrical or conical cavity 104 arranged to rotationally accept a plug and handle combination 150 such as shown as in the two viewing perspectives of FIGS. 1d and 1e.

The conventional lab glassware valve body 103 provides both an outer encasement and a conical or cylindrical cavity in which the plug 150 is inserted and rotates within. The plug 150 shown in FIGS. 1d and 1e comprises a shaft region 114 and typically comprises a handle or handle region 110 attached to a shaft or shaft region 114. The two viewing perspectives of FIGS. 1d and 1e differ by a rotation of the plug handle 110 by approximately 90 degrees. There is a passageway 115 through the shaft region 114 of the plug 150. The plug 150 also typically comprises an end-cap region 111 that features a groove 116 for accepting a securing grommet, elastic ring, or clip such as the one 112 depicted in FIG. 1a. The handle 110 can be angularly rotated, for example by hand, to various other positions 110a-110c as suggested in FIG. 1f. Typically the plug is free to rotate a full 360 degrees, but only a narrow range of angles permit flow through the stopcock.

Many other forms and types of each of these elements and their component parts known by one skilled in the art, for example ones with additional outlet inlet tubes connecting with the valve body 103 and with additional passageways through the plug.

Traditionally the passageway 115 through the shaft region 114 of the plug 150 is of small diameter relative to the diameter of the shaft region 114 of the plug 150, and typically is of comparable size to the internal open diameter of the inflow/outflow tubes 101, 102. Additionally, the cavity in the valve body 103, the plug 150, the inflow/outflow tubes 101, 102, and the passageway 115 through the plug 150 are arranged so that:
The plug 150 can be turned to a first range of angular positions wherein the passageway 115 through the plug 150 meets at least in part an internal open aperture through the encasement connecting to the open volumes within of the inflow/outflow tubes 101, 102. In this first range of angular positions, flow through the inflow/outflow tubes 101, 102 can occur via the passageway 115 through the plug 150. When the passageway is fully aligned with the inflow/outflow tubes 101, 102, maximal flow can occur. When the passageway is partially aligned with the inflow/outflow tubes b, a reduced rate of flow can occur.
Outside this first range of angular positions, the passageway 115 through the plug 150 is configured to not align with the internal open diameter of the inflow/outflow tubes 101, 102. In this case, flow through the inflow/outflow tubes 101, 102 is blocked.

FIG. 1g shows additional detail of the alignment of the passageway 115 through the plug with the apertures through the encasement connecting to the inflow/outflow tubes 101, 102. The example alignments depicted in FIG. 1g include a fully-blocked case 151, a fully-open case 155, and various partially-open cases 152-154 permitting various amounts of flow through the plug 150 as increasing fractions of the passageway aligns with the aperture. As the stopcock handle is rotated, the exposed cross-section of the plug passageway 114 that aligns with the apertures through the encasement connecting to the inflow/outflow tubes 101, 102 that, for example, had been blocked (say with handle position 110a in FIG. 1f) becomes (as the handle is rotated through the continuous range of positions that include 110, 110b, 110c) increasing larger 152-154 until the entire area of the cavity becomes fully opened 155 and then becomes smaller again until the passageway is not exposed and the aperture is completely blocked.

As mentioned above, typically the plug is free to rotate a full 360 degrees, but only a narrow range of angles permit flow through the stopcock. This is because traditionally the passageway 115 through the plug 150 is of small diameter, in particular typically of a diameter comparable to the internal open diameter of the inflow/outflow tubes 101, 102, the range of angular positions that permits flow is relatively small. Thus, most of the 360 degrees of angular rotation of the handle (and attached plug) deliver blocked flow, and only a small angle of rotation provides flow through the stopcock, as suggested in FIG. 1h. Because the passageway 115 through the plug 114 is typically symmetric, any two handle 110 (and associated plug 114) positions that exactly differ by 180 degrees of rotation provides the same flow behavior, as suggested in FIG. 1h.

Further, because only a small angle of rotation provides flow through the stopcock, it is typically extremely difficult to even roughly control the partial flow rate through the stopcock by selectively rotating the handle 110 to a specific range of desired partial flow positions (i.e., such as 152-154 in FIG. 1g.

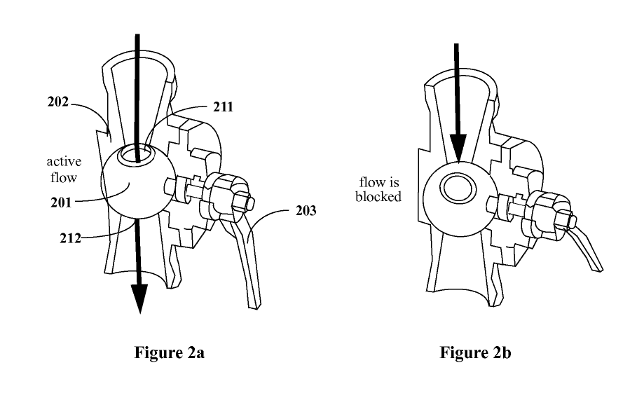

Similar arrangements are available with the rotating member is in the form of a spherical “ball” rather than cylindrical or conical plugs. FIG. 2a illustrates a conventional ball-type rotary valve, in particular one that is used in facilities and industry. Here, spherical ball 201 rotates within a special chamber 202 under the mechanical control of a rotating shaft 203, which may for example be attached to a rotating handle 203 (or hand operated wheel) for hand operation. The spherical ball 201 further comprises two openings 205 positional diagonally antipodal on the spherical ball 201, these openings serving as vestibules to a passageway through the spherical ball 201. When the passageway is aligned with inlet port 211 and outlet port 212, as shown in FIG. 2a, flow is enabled through the valve. When the openings and passageway are aligned with inlet port 211 and outlet port 212, as shown in FIG. 2a, flow is enabled through the valve. When the openings and passageway are not aligned with inlet port 211 and outlet port 212, as shown in FIG. 2b, flow is prevented through the valve. When the openings and passageway are partially aligned with inlet port 211 and outlet port 212, a reduced rate flow is enabled through the valve. It is noted that many other ball valve embodiments are know as is appreciated by one skilled in the art, the operation principles accordingly being similar to that of a plug valve as is familiar to one skilled in the art. Collectively, rotating plug valves and rotating ball valves will be termed as “rotary valves” as is a customary term in the art.

As mentioned earlier, many other forms and types of each of these elements and their component parts known by one skilled in the art, for example ones with additional outlet inlet tubes connecting with the valve body and with additional passageways through the plug or ball.

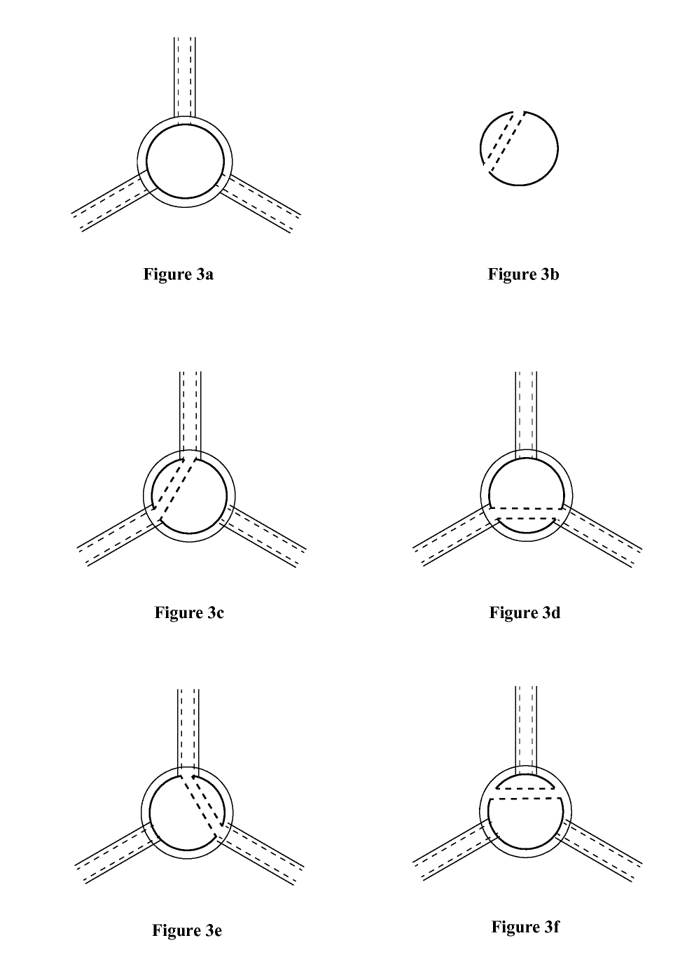

As an example in the case of plug valves, FIGS. 3a-3f depict a first structure, components, and operation of a conventional plug-type rotary “stopcock” valve traditionally employed in laboratory glassware wherein a third inlet/outlet tube is provided. FIG. 3a depicts a conventional lab glassware valve body again comprising an outer encasement and is internally configured with a cylindrical or conical cavity arranged to rotationally accept a rotary plug and handle combination. FIG. 3b depicts a cross-section view of plug illustrating in dashed lines a single passageway borehole through the plug. FIGS. 3c-3e depict three possible flow paths through the passageway that can be selected through rotation of the plug. Note these are mutually exclusive and that there is no mode allowing all three inlet/outlet tubes to be simultaneously interconnected. FIG. 3f depicts an exemplary rotational position of the plug that blocks all flow through the stopcock.

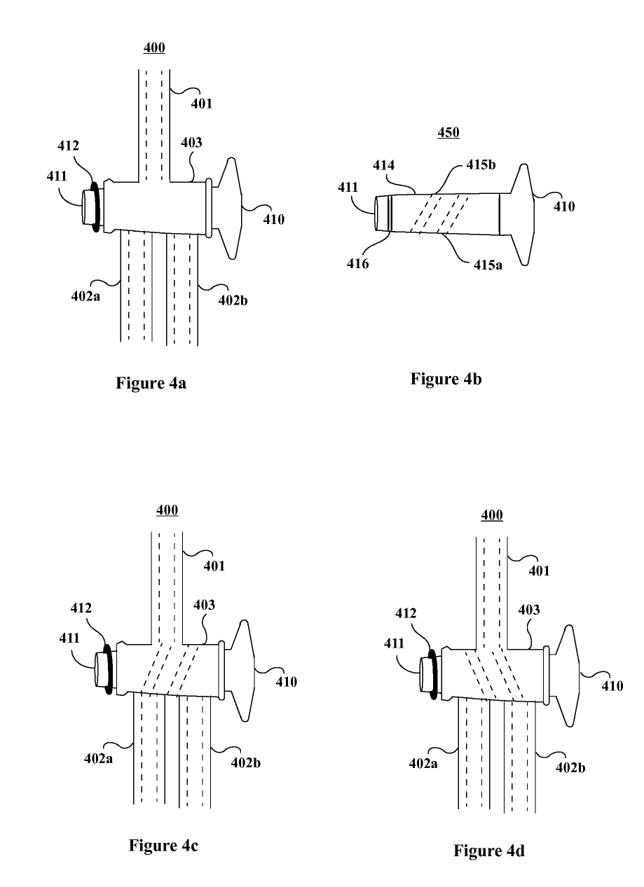

FIGS. 4a-4d depict a second structure, components, and operation of a conventional plug-type rotary “stopcock” valve traditionally employed in laboratory glassware wherein three inlet/outlet tubes 401, 402a, 402b are provided. FIG. 4a depicts a conventional lab glassware valve body 403 again comprising an outer encasement and is internally configured with a cylindrical or conical cavity arranged to rotationally accept a rotary plug and handle combination (comprising for example visible elements 410 and 411). FIG. 4b depicts a cross-section view of a plug arrangement 450 illustrating in dashed lines two slanted passageway boreholes 415a, 415b through the plug body 414. The plug 450 also typically comprises an end-cap region 411 that features a groove 416 for accepting a securing grommet, elastic ring, or clip such as the one 412 depicted in FIG. 4a. FIGS. 4c-4d depict two possible flow path modes that can be selected through rotation of the plug. In this example, the associated angular positions of these two flow modes are separated by 180 degrees of rotation. Note these two flow modes are mutually exclusive and that there is no mode allowing all three inlet/outlet tubes to be simultaneously interconnected. The flow can be completely blocked by rotating the plug to any one of a range of angular positions where the passageway boreholes 415a, 415b do not line up with the inlet/outlet tubes 401, 402a, 402b.

Although not found in traditional glassware, it is inventively noted that the two slanted passageway boreholes 415a, 415b through the plug body 414 need not be coplanar. For example, one of the two slanted passageway boreholes 415a, 415b through the plug body 414 can be oriented 90 degrees from the orientation depicted in FIG. 4b. In such an arrangement, two possible flow path modes can still be selected through rotation of the plug, however here the associated angular positions of these two flow modes are separated by 90 degrees of rotation. Again these two flow modes are mutually exclusive and there is no mode allowing all three inlet/outlet tubes to be simultaneously interconnected. The flow can be completely blocked by rotating the plug to any one of a range of angular positions where the passageway boreholes do not line up with the inlet/outlet tubes 401, 402a, 402b.

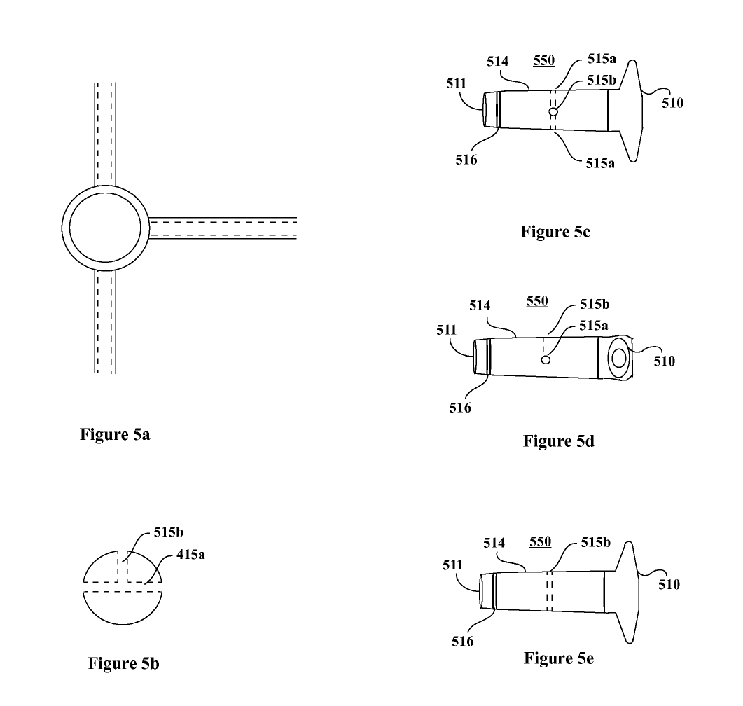

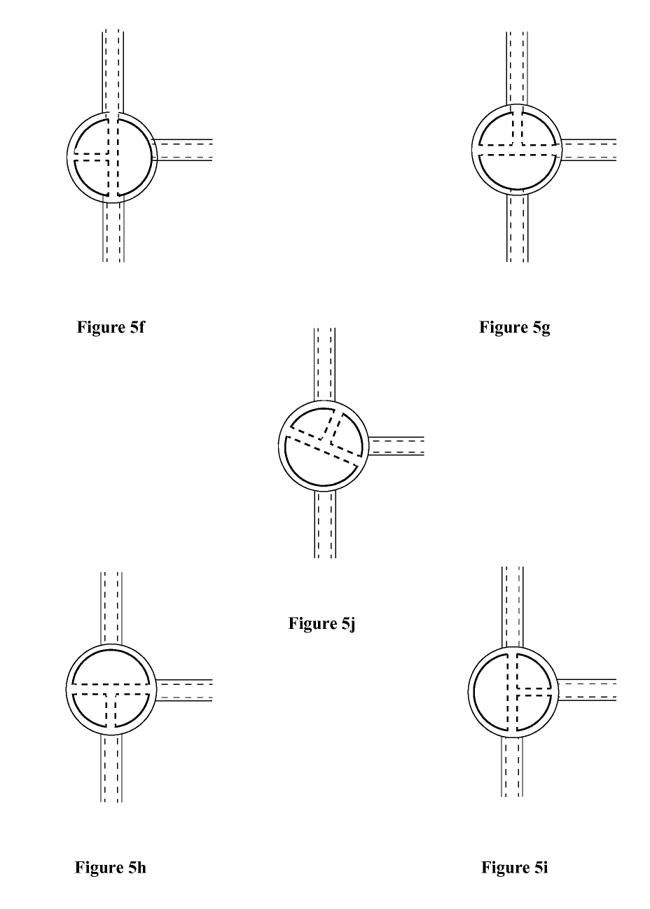

FIGS. 5a-5e depict a third structure and components of a conventional plug-type rotary “stopcock” valve traditionally employed in laboratory glassware wherein three inlet/outlet tubes are provided. FIG. 4a depicts a conventional lab glassware valve body again comprising an outer encasement and is internally configured with a cylindrical or conical cavity arranged to rotationally accept a rotary plug and handle combination. FIG. 4b depicts a cross-section view of a plug illustrating in dashed lines a “T”-shaped (three-opening) passageway through the plug. The a “T”-shape can be realized, for example by drilling or casting-out a radial (half-diameter) length borehole intersecting and perpendicular to the passageway 115 of in the plug body 114 depicted in FIG. 1d. The plug 550 also typically comprises an end-cap region 511 terminating the plug body 514; the end-cap region 511 can comprise a groove 516 for accepting a securing grommet, elastic ring, or clip.

FIG. 5c depicts an exemplary side view of the full plug 550 wherein the radial length borehole 515b faces towards the reader and the diameter-length passageway 515a is positioned vertically. FIG. 5d depicts an exemplary side view of the full plug 550 wherein plug handle of FIG. 5c has been rotated by 90 degrees in a direction so that the radial length borehole 515b is facing upwards and the diameter-length passageway 515a faces the reader. FIG. 5e depicts an exemplary side view of the full plug 550 wherein plug handle of FIG. 5d has been further rotated by 90 degrees in the same direction so that the diameter-length passageway 515a is now positioned vertically but the radial length borehole 515b faces away from the reader. FIGS. 5f-5j depict four possible flow paths through the passageway that can be selected through rotation of the plug:
With the plug 550 rotationally positioned as shown in FIG. 5f, the top and bottom inlet/outlet tubes are interconnected;
With the plug 550 rotationally positioned as shown in FIG. 5g, the top and side inlet/outlet tubes are interconnected;
With the plug 550 rotationally positioned as shown in FIG. 5h, the side and bottom inlet/outlet tubes are interconnected;
With the plug 550 rotationally positioned as shown in FIG. 5i, all three (i.e., top, side and bottom) inlet/outlet tubes are interconnected
   FIG. 5j depicts an exemplary rotational position of the plug that blocks all flow through the stopcock.

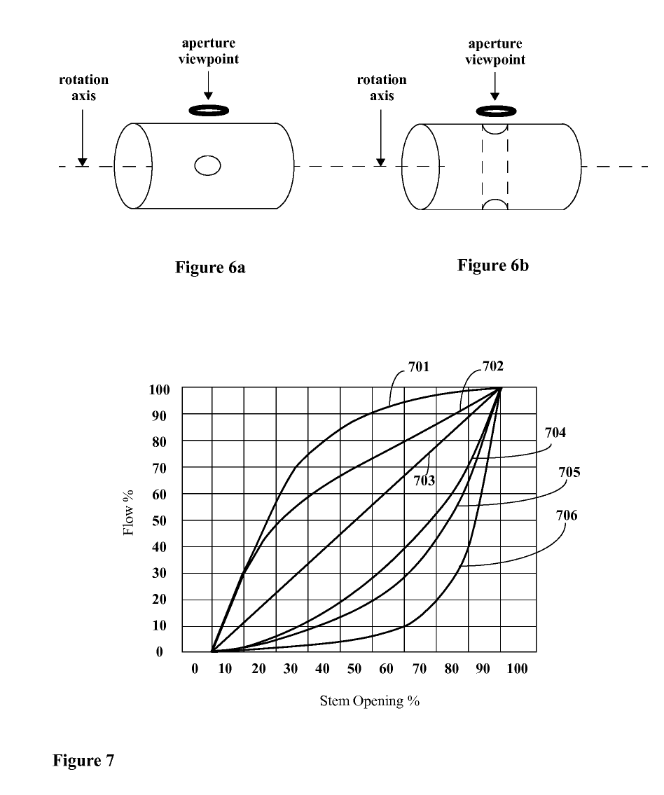

FIG. 6a depicts a plug of a plug valve used in a laboratory glassware stopcock showing a cylindrical hollow passageway through the plug. With respect to the position of the aperture as depicted, FIG. 4a depicts the rotational element in a position that blocks flow that would be directed through the aperture. FIG. 6b depicts the arrangement of FIG. 4a wherein the rotational element is rotated 90 degrees about the rotation axis allowing maximum flow directed through the aperture.

Plug-style stopcock valves as used in traditional chemistry laboratory glassware typically offer only a cylindrical or conical passageway whose diameter is a tiny proportion of the overall cross-sectional circumference of the plug (for example as depicted in FIG. 6a). As a result, only a tiny proportion of the overall possible stopcock plug rotational angle is useful for permitting, much less regulating, flow. The remainder of the angular range is devoted to completely blocking the flow. Because of the small proportion of possible rotation angle is available for allowing (much less regulating) flow, adjustment is often difficult and precise flow control can be in many circumstances nearly impossible to reliably attain.

Thus, in addition to the types of stopcocks presented above, some laboratory glassware employs another type of valve structure typically referred to as “metering valves.” These comprise a threaded element providing multi-turn fine adjustment of flow through the valve. However, these are expensive and rarely used in stock glassware.

A somewhat more developed situation is available to some extent in the area of industrial valves. FIG. 7 shows flow responses as a function of angular rotation angle of the rotating element for various types of industrial valves. The flow rate varies according to a mathematical relationship (linear, quadratic, exponential, log, etc.) with the angle of rotation. These response curves may be realized by cams. Passageway shape may additionally vary with pressure due to viscosity, eddy, and turbulence effects, etc. Industrial plug and ball valves are manufactured with different angular flow responses rated under specified conditions.

Converting Laboratory Glassware Stopcock Technologies into Metering Valves (“Metered Stopcock Technologies”)

In the below, a plug body is depicted as longitudinally cylindrical, but the same principles apply for a longitudinally conical plug body as well as a spherical (“ball valve”) or ellipsoidal (flattened-sphere) rotating member.

The present invention provides one or more of the following improvements:
The passageway of a laboratory stopcock, plug valve or ball valve is elongated along the direction of rotation with decreasing cross-sectional area that varies monotonically with the rotation angle for a significant portion of the range of rotation angle.
The monotonic variation in passageway cross-sectional area is engineered to obtain a desired angular flow response.
The rotation of a laboratory stopcock is controlled by a motor or servo to create a signal-controllable valve.

The present invention includes provisions for employing at least one elongated opening in the plug arranged so that the cross-sectional area of the flow path more gradually changes as the plug is rotated. For example, the angular positions permitting flow can be accordingly be expanded from just a few degrees of rotation to much larger ranges, even approaching just short of 180 degrees of rotation. The shape of the elongated opening in the plug can be designed to provide gradually changes in the flow as the plug is rotated, and further can be designed to provide desired variation in cross-sectional area permitting flow through the plug as a function of plug rotation angle.

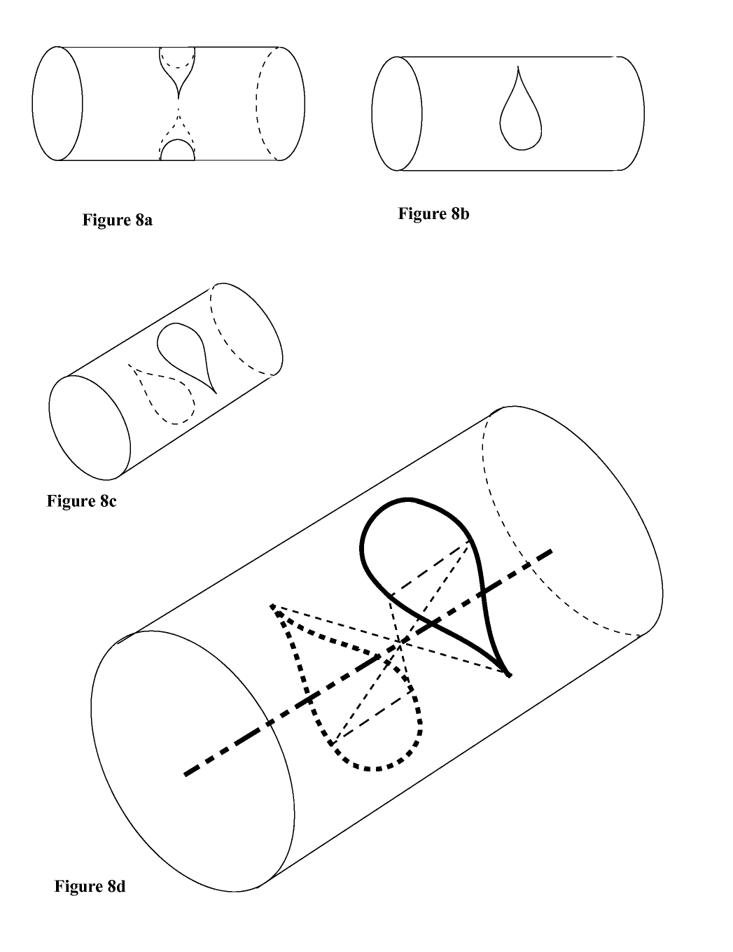

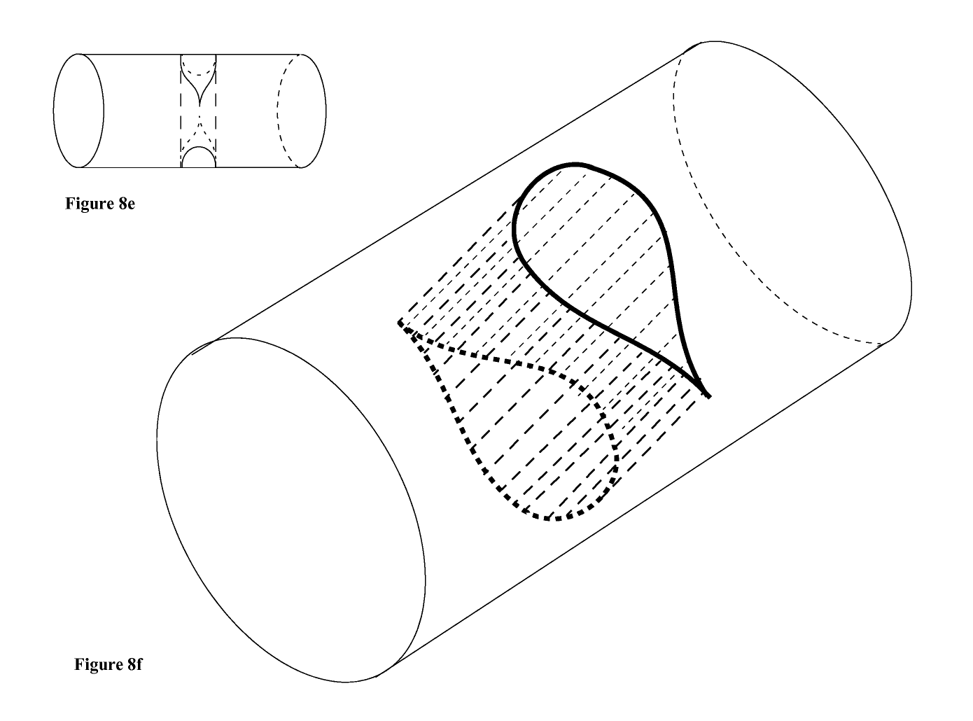

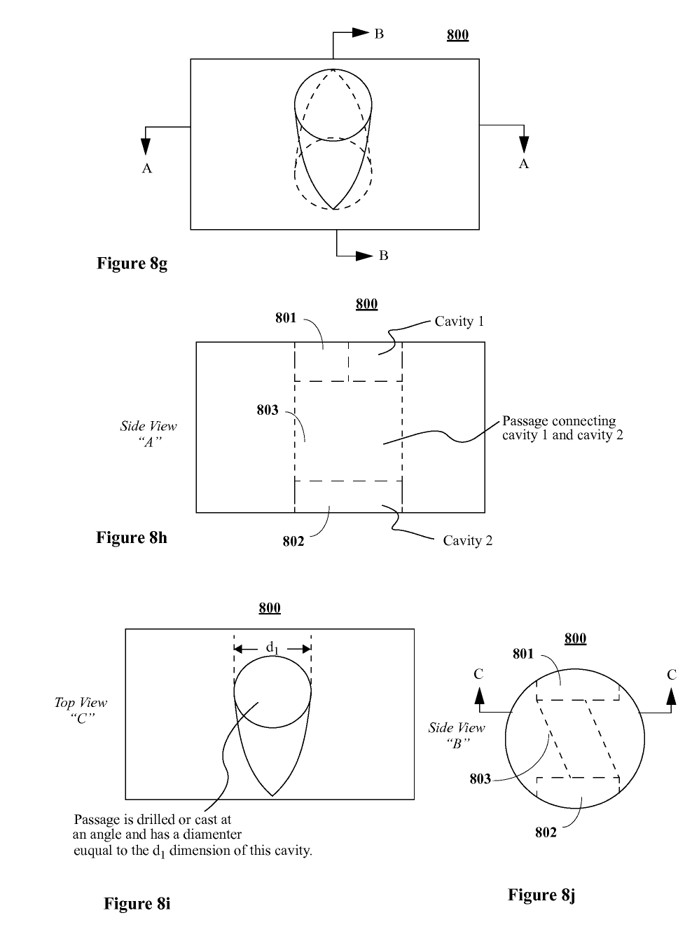

FIGS. 8a-8j depicts a portion of an exemplary plug element provided for by the invention comprising an elongated opening on diametric sides of the plug connected by a hollow passageway through the plug. Such an elongated opening provides a cross-sectional area as presented to the stopcock aperture that varies monotonically with the rotational angle for at least a portion of the permitted rotation angle. Here the elongated opening on diametric sides of the plug is drawn as teardrop-shaped, but other types of shapes and variations in local convexity in various portions of the shape are possible and are provided for by the present invention.

FIG. 8a depicts a side view of the plug. Here only partial views of these two openings in the plug are directly visible, and obscured portions of the openings are rendered in dashed lines. FIG. 8b shows the same plug rotated about a 90-degree angle wherein one of the elongated openings is fully visible to the reader and the corresponding opening on the opposite side of the plug is not seen. FIG. 8c shows a spatially rotated view wherein one of the elongated openings is fully visible to the reader and the corresponding opening on the opposite side of the plug is rendered in dashed lines. In this example the elongated openings are aligned and oriented so that the width of the opening of one opening (as measured with respect to the length of the plug) is the same as the width of the opening of the opposite opening (as measured with respect to the length of the plug) as projected through the centerline of the length of the plug. Two examples of such width matching through the centerline are shown in FIG. 8d. Although other configurations are possible and provided for by the invention, the alignment and orientation causes each aperture (of the valve body connecting to the two inlet/outlet tubes) to be presented with the same cross-sectional area at each position of angular plug rotation. FIG. 8e shows a view of FIG. 8a wherein the connections between the two openings are connected by a passageway. FIG. 8f shows the 3D outline of the passageway in more detail.

FIGS. 8g-8j depict the general principles described above with an alternate treatment of the passageway between the elongated openings. FIG. 8g shows a presentation of FIG. 8b wherein the elongated opening on the opposite side of the plug is shown in dashed lines. Accordingly, FIG. 8g amounts to a 90 degree rotation of the depiction in FIG. 8e about the longitudinal axis of the plug, but also shows a circular opening to the passageway joining the two elongated openings. In this approach the opening is cylindrically shaped or nearly-cylindrically shaped, the cylinder comprising a radius equal to or nearly-equal to widest portion of the elongated opening, as suggested in FIG. 8i. Note that if the passageway is circularly-cylindrically shaped, the widest portion of elongated openings can conform to this circular curvature. The invention provides for the non-circular cross-section cylindrically shaped passageways, for example as can be cast in a polymer or glass plug body allowing non-circular curvature in the widest areas of the elongated openings advantageous in certain flow designs, for example the more general versions of elongated opening designs.

FIG. 8h depicts a first orthogonal side (“A-A”) view of the arrangement depicted in FIG. 8g. In this arrangement, each elongated opening exposes a corresponding cavity 801, 802 which are joined by a passageway 803. In one implementation, the passageway 803 is diametrically aligned in the plug, and for example may resultantly interface the cavities 801, 802 at an angle as depicted in the second orthogonal side (“B-B”) view of the arrangement depicted in FIG. 8j. It is noted that although the cavities 801, 802 depicted the arrangement depicted in FIG. 8j are depicted with flat basins, the cavity basins in general can be of a wide variety of shapes involving one or more locally curved or planar surfaces.

As a first example of the invention, the arrangements described above in conjunction with FIGS. 8a-8j can be used to replace, for example, the body portion 114 of plug 150 depicted in FIGS. 1d and 1e.

As a second example embodiment of the invention, in a similar fashion, the elongated opening and passageway can be incorporated into the body portion 114 of plug 150 depicted in FIGS. 1d and 1e and rendered on a slant so as to produce an alignment such as that depicted in FIG. 3b, adapting it for use in the three inlet/outlet valve described earlier in conjunction with FIGS. 3a-3f.

As a third example embodiment of the invention, in a similar fashion, a second such elongated opening and diameter-length passageway can be incorporated into the body portion 114 of plug 150 depicted in FIGS. 1d and 1e and rendered on a slant so as to produce an alignment such as that depicted in FIG. 4b. This results in an adaptation for use in the three inlet/outlet valve described earlier in conjunction with FIGS. 4a-4d.

As a fourth example embodiment of the invention, the second such elongated opening and passageway described above can be oriented at 90 degrees to that of the first elongated opening and passageway.

As a fifth example embodiment of the invention, a second such elongated opening and radial-length passageway can be incorporated into the body portion 114 of plug 150 depicted in FIGS. 1d and 1e and rendered to perpendicularly intersect the first elongated opening and passageway can be incorporated into the body portion 114 of plug 150 in an alignment such as that depicted in FIG. 5b. This results in an adaptation for use in the three inlet/outlet valve described earlier in conjunction with FIGS. 5a-5j.

Accordingly with the above teachings and their natural extensions as is clear to one skilled in the art, the present invention provides for employing at least one elongated opening in the plug arranged so that the cross-sectional area of the flow path more gradually changes as the plug is rotated. As a result, the angular positions permitting flow can be accordingly be expanded from just a few degrees of rotation to much larger ranges, even approaching just short of 180 degrees of rotation for some arrangements (first and third embodiments), just short of 135 degrees of rotation for other arrangements (some forms of fourth embodiments), just short of 90 degrees of rotation for other arrangements (fifth and other forms of fourth embodiments), and just short of 60 degrees of rotation for yet other arrangements (second embodiment).

The resulting arrangement allows for the control of flow through a conventional stopcock comprised by conventional glassware.

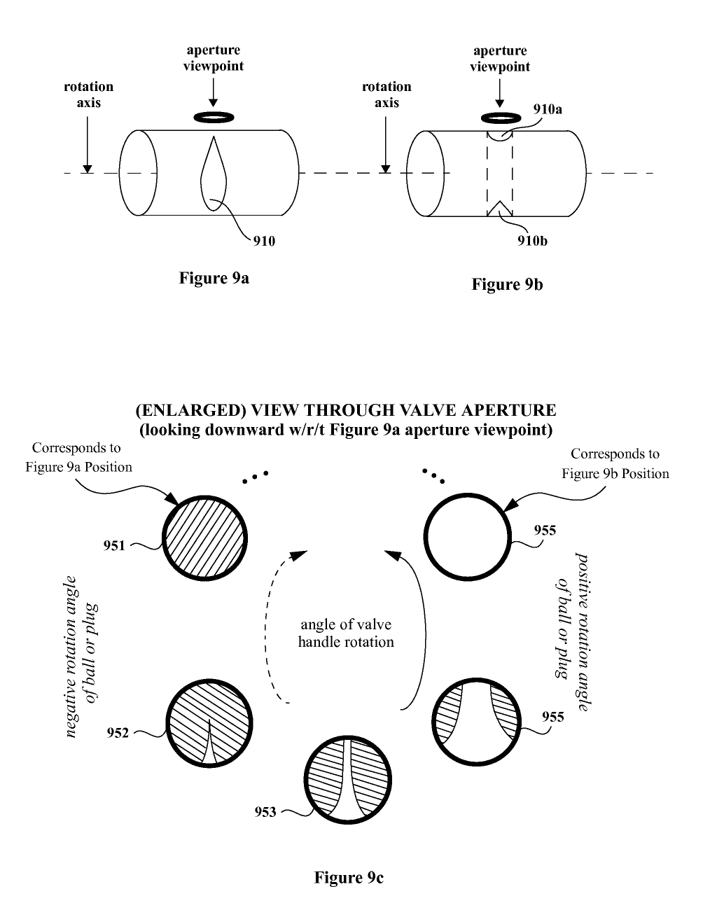

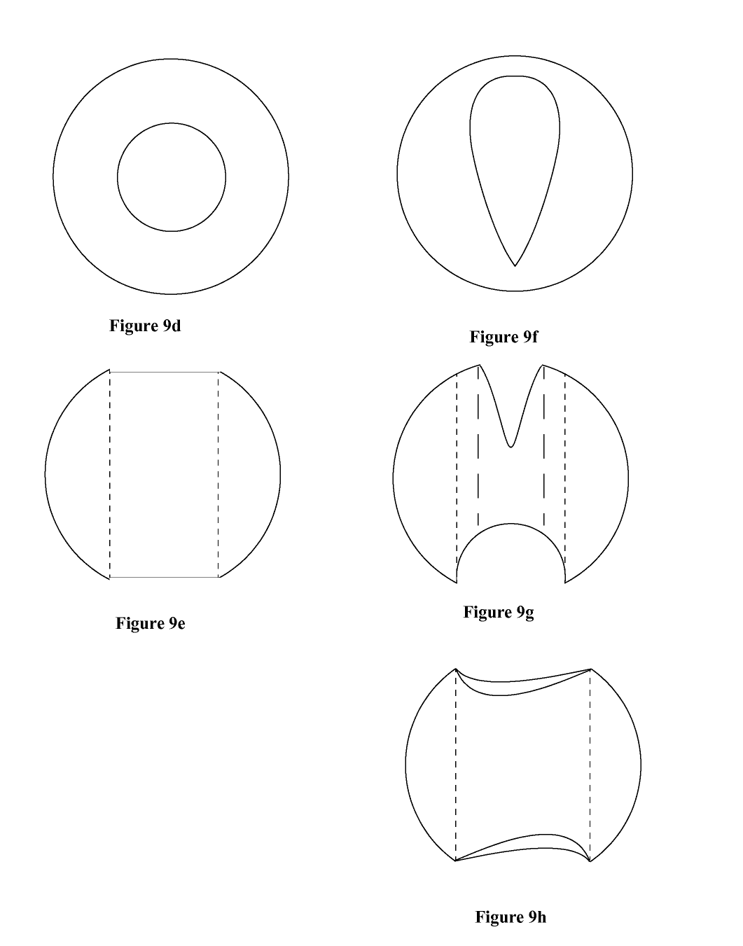

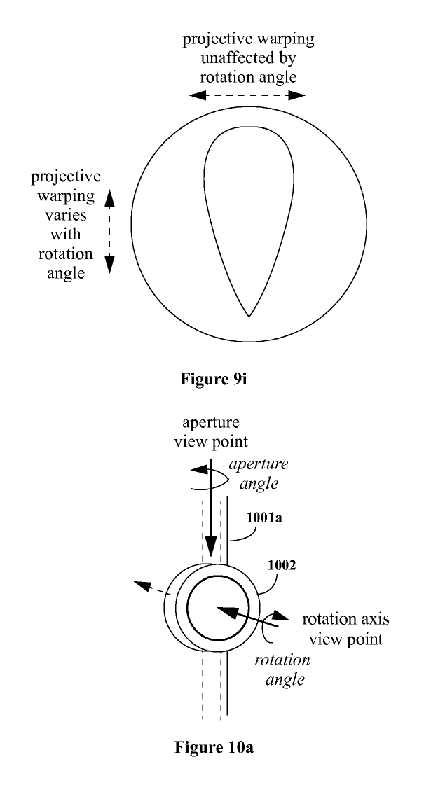

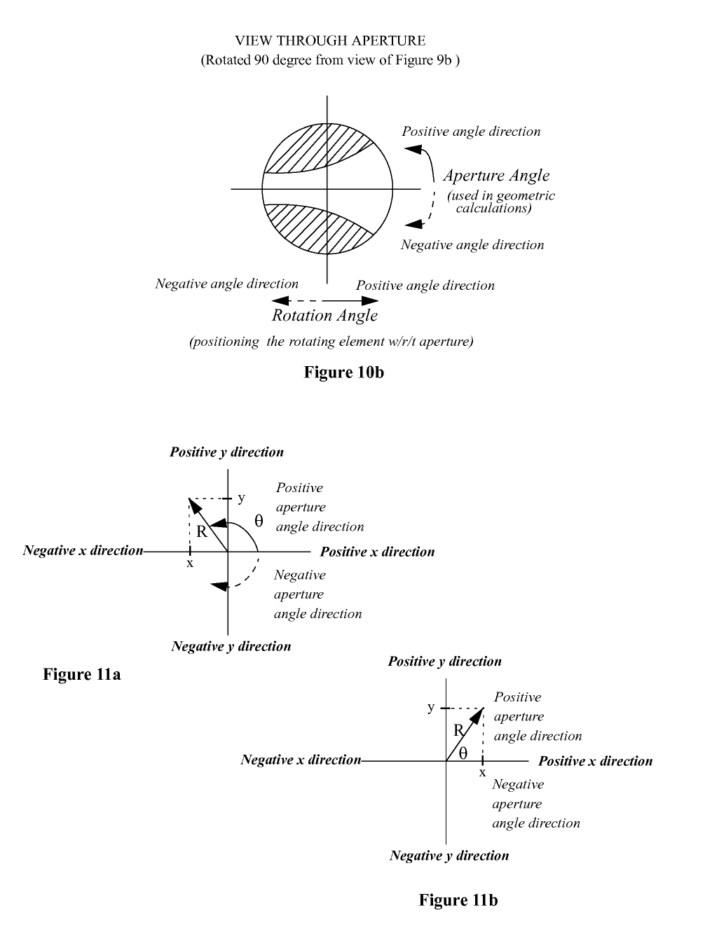

FIG. 9a depicts a rotating element the shape of the passageway is adapted for more control of the flow rate and angular flow response. The element shown in FIG. 9a shows an elongated hollow passageway through the element wherein the shape of the passageway is explicitly used to define the flow response. Additional detail will be provided as to design of the passageway shape. FIG. 9a depicts the rotating element in a position that blocks flow through the aperture 910. FIG. 9b depicts the arrangement of FIG. 9a wherein the rotational element is rotated by 90 degrees allowing some flow directed through the apertures 910a, 910b.

FIG. 9c illustrates shapes of the exposed portion of the passageway as seen through the aperture varying with the angular position of the rotating element. Again, as will be described later, these views show the passageway in a projected view, causing a distortion of the passageway shape due to the curvature of the rotating element. The depicted full-off case 951 relates to rotary element positions such as that of FIG. 9a, while the depicted full-on case 955 relates to rotary element positions such as that of FIG. 9b. The other depicted exemplary cases 952-954 depict increasing amounts of permitted flow as increasing portions of the passageway aligns with the aperture.

Although explained thus far in terms of plug valves, a similar approach can be applied to the rotating elements of ball valves. FIGS. 9d and 9e depict two orthogonal views of a traditional ball valve rotating element comprising a circular passageway. This arrangement may be viewed as being analogous to the stopcock plug valve rotating element depicted in FIG. 6a.

FIGS. 9f through 9h depict three orthogonal views of a modified ball element the invention comprising an elongated hollow passageway through the ball with cross-sectional area that varies monotonically with the rotational angle for at least a portion of the permitted rotation. This arrangement may be viewed as being analogous to the inventive stopcock plug valve rotating element depicted in FIG. 9a. The modified ball element depicted in the three orthogonal views of FIGS. 9f through 9h show an elongated hollow passageway through the ball element wherein the shape of the passageway is explicitly used to define the flow response.

FIG. 9i depicts the rotating ball element of FIGS. 9f through 9h of the invention, additionally labeled to consider projection effects on the aperture view of the passageway. Here the view chosen is that of FIG. 9f. The angle of ball element rotation moves in an arc parallel to the dashed vertical line on the left side of FIG. 9i. The impact of this projection effect on the shape of the passageway as seen in the aperture view of the passageway (and thus as experienced by flow through the passageway) is a function of valve element rotation angle.

In the orthogonal direction represented by the horizontal dashed line at the top of FIG. 9i the rotating ball element does not curve, so there has been no need to consider projection effects. In the case of a ball valve rotating element, there is however curvature in the direction represented by the depicted horizontal dashed line at the top of FIG. 9i. This does cause a projection effect on the aperture view of the passageway, resulting in an effective narrowing of the passageway (more specifically, a narrowing in the horizontal direction in FIG. 9i) as seen in the aperture view of the passageway and thus as experienced by flow through the passageway. However, the impact of this projected effect narrowing is not a function of valve element rotation angle; this narrowing projective effect is invariant to the angle of ball element rotation as the angle of curvature in the horizontal direction of FIG. 9i is orthogonal to the angle of ball element rotation depicted vertical direction of FIG. 9i.

As a result, the projection effect on the shape of the passageway as seen in the aperture view of the passageway (and thus as experienced by flow through the passageway) as a function of valve element rotation angle can be considered for plug element geometries without loss of generality. These results may be inherited directly by ball valve elements by simply including the effective narrowing of the passageway in the depicted horizontal direction in FIG. 9i as an independent operation warping the coordinate system of the curves to be described such as f(x).

### Analytic Calculation of Flow Through Cross Section Passage

FIG. 10a illustrates two viewpoints rotating to valve attributes that are used in describing the invention. The aperture viewpoint is one equivalent to looking through one of the internally open interior of inflow/outflow tubes 1001a, 1001b (or their equivalents in another type of embodiment) in the direction of the rotary plug or ball of the valve enveloped by the rotation chamber 1002. The rotary axis viewpoint is one aligned with the axis of rotation of the plug or valve. The rotary axis viewpoint is typically orthogonal to the aperture viewpoint, as suggested in FIG. 10a.

FIG. 10b illustrates an example of range of possible cases in FIG. 9b, for example the case 953. Specifically, the view of FIG. 10b is that of element 953 rotated by 90 degrees so as to advantageously define coordinate systems useful in computations.

In FIG. 10b, both an aperture angle θ and rotation angle α are defined.
The rotation angles α represents the angle at which the rotating element is positioned. It will be convenient for a to represent angles in units of radians so that the quantity a can further be used in measuring arc length.
The aperture angle θ results from the circular cross-sectional shape of the cavity and may be used for polar-coordinate calculations of the cross-sectional diameter of the passageway and the area. For these calculations, it is arbitrary whether aperture angle θ is in units of degrees or radians.

Since the passageway cross-sectional area and the rate of flow share a monotonic (and sometimes nearly proportional) relationship, then in order to assess the rate at which a fluid or gas can flow through a rotary valve, the cross-sectional area of the passageway exposed to the aperture must be obtained or estimated. Turbulence and edge eddy currents will be discussed later.

In order to calculate the open (unshaded) area depicted in FIG. 10b, both polar coordinate system and Cartesian coordinate system will be used. FIG. 11a depicts the relationship between the two different coordinate systems, including details of geometric direction, algebraic sign, etc. Here the traditionally used variables x and y denote position in the Cartesian coordinate system, and r and 8 denote aperture radius r and aperture angle θ used in the polar coordinate system. The aperture angle θ and the aperture Cartesian (rectangular) coordinates x and y may assume values that are positive, zero, or negative. The aperture radius r is a positive value.

Conversion to the Cartesian (rectangular) coordinate system from the polar coordinate system is obtained by the following equations, here stated in terms of variables that will be used later:

x=R cos θ

y=R sin θ

Conversion to the polar coordinate system from the Cartesian (rectangular) coordinate system is obtained by the following equations, here stated in terms of variables and inverse trigonometric functions that will be used later:

$$R = \sqrt{{x}^{2} + {y}^{2}}$$

$$θ = arccos ( \frac{x}{R} )$$

$$θ = arcsin ( \frac{y}{R} )$$

$$θ = arctan ( \frac{y}{x} )$$

The angle equation may be chosen by the domain and range of the candidate inverse trigonometric function or by other criteria required by or opportune to calculation.

In order to make further definitions applicable to analytic aspects of the invention, consider the situation where the rotary element within the valve is positioned so that fluid or gas may flow though it. This requires the rotary element of the valve to be positioned so that some portion of the passageway 910 in FIG. 9a aligns with the open orifices of the inflow and outflow tubing elements 1001a, 1001b.

Within the aperture, the boundary of the open cavity of the rotary element, as seen looking into the aperture from the aperture viewpoint can be thought of as either a function of one of a Cartesian (rectangular) or a function of one of polar coordinates imposed on the view through the aperture.

In one aspect of the invention, the passageway of a laboratory stopcock, plug valve or ball valve is elongated with respect to the direction of rotation with decreasing cross-sectional area that varies monotonically with rotation angle for a significant portion of the possible range of stopcock, plug or ball rotation angle. In another aspect of the invention, the monotonic variation in passageway cross-sectional area is engineered so as to obtain a desired angular flow response. In this section, an analytical framework as resultant calculations and inventive engineering is described capable of charactering and addressing both these aspects of the invention.

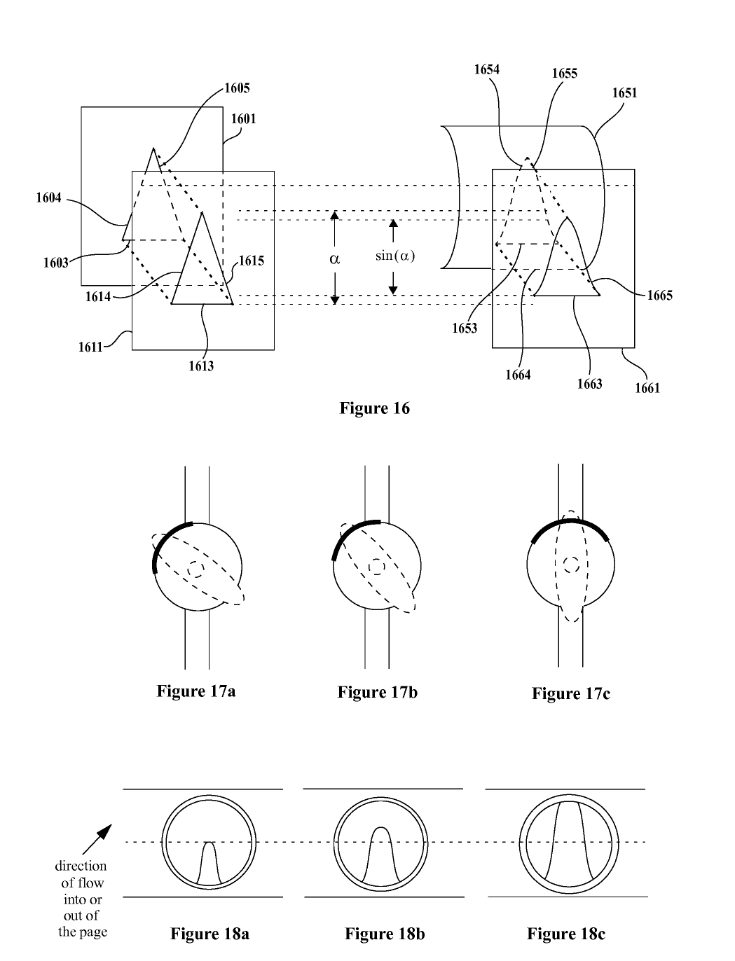

In the framework and analysis to follow, the shape of the passageway is symmetric about a centerline that is perpendicular to the axis of rotation of the rotating element, and further that the shape of the passageway is defined on one side of the centerline by a function f(x) where x is a variable representing the rectangular coordinate of the aperture that is parallel with the direction of rotation of the rotating element. Due to the just-assumed symmetry of the rotating valve element, the shape of the passageway on the other side of the centerline would therefore be defined by the function −f(x). Typically f(x) is monotonic for at least a portion of the range of operative rotation of the rotating element. The function f(x) may be a piecewise linear function. However, in general, it can be advantageous for f(x) to be a nonlinear function of x for a number of reasons including a sine-function projective warp effect along the circumference of the plug (illustrated and discussed later in conjunction with FIG. 16).

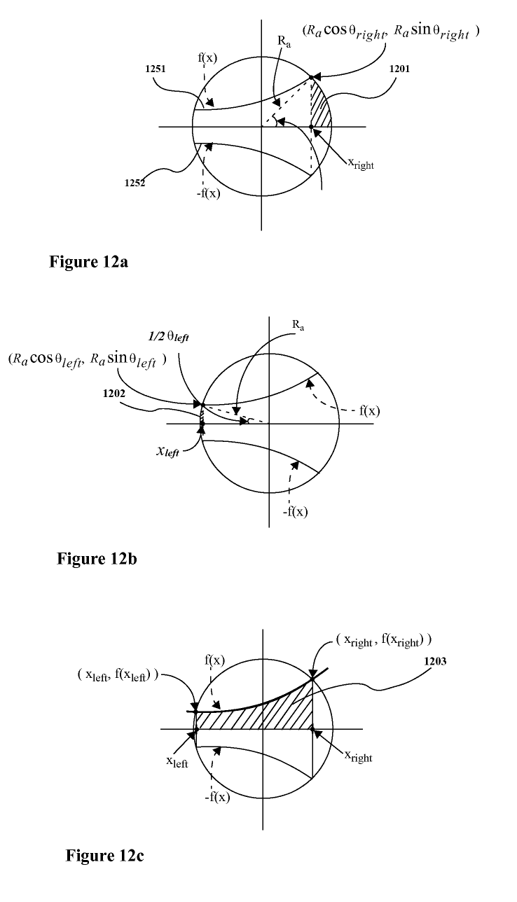

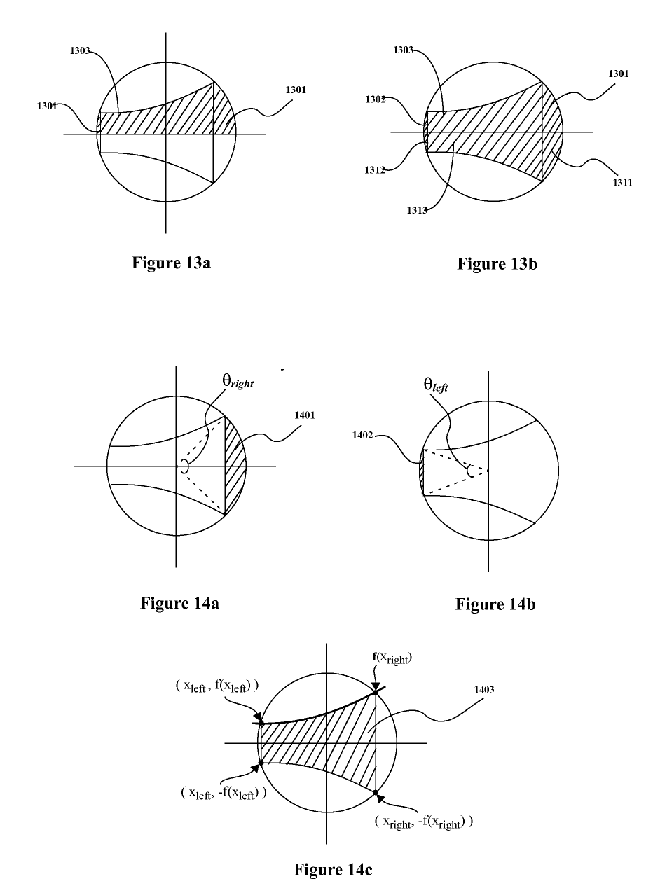

In order to calculate the cross-sectional area of the flow area through the aperture as constricted by the exposed passageway, illustrated in FIG. 10b, it is advantageous to partition the region into three segments or sub-regions. FIG. 12a-12c each depicts three segments of the cross-section area for each part of calculation. In FIGS. 12a-12c, the x coordinate described above is portrayed in the horizontal direction. Again note the x coordinate represents the rectangular coordinate of the aperture that is parallel with the direction of rotation of the rotating element.

As to the aforementioned segments in the depictions of FIGS. 12a-12c, θ_{right} and x_{right} represent the angle and right-hand limiting abscissa of the triangle depicted in FIGS. 12a and 12c, while θ_{left} and x_{left} represent the angle and left-hand limiting abscissa of the triangle depicted in FIGS. 12b and 12c.

The shaded area in FIG. 1201 12a is obtained by the following:

$$\begin{matrix}Area [ Figure 12 a ] = ( \frac{{θ}_{right}}{2} \frac{1}{2 π} ) ( π {R}^{2} ) - \frac{1}{2} ( \begin{matrix}R cos ( \frac{{θ}_{right}}{2} ) * \\ R sin ( \frac{{θ}_{right}}{2} )\end{matrix} ) \\ = ( \frac{{θ}_{right}}{4} ) {R}^{2} - \frac{{R}^{2}}{2} ( cos \frac{{θ}_{right}}{2} sin \frac{{θ}_{right}}{2} ) .\end{matrix} \qquad \begin{matrix}\begin{matrix}\begin{matrix}\begin{matrix}( 1 ) \\ \end{matrix} \\ \end{matrix} \\ \end{matrix} \\ ( 2 )\end{matrix}$$

where the sine and cosine terms provide the two sides of a right-triangle. Using the trigonometric double angle formula for sin:

sin 2θ=2 cos φ sin φ (3)

eq(3) reduces to

$$\begin{matrix}Area [ Figure 12 a ] = ( \frac{{θ}_{right}}{4} ) {R}^{2} - \frac{{R}^{2}}{4} sin {θ}_{right} & ( 4 ) \\ = \frac{{R}^{2}}{4} ( {θ}_{right} - sin {θ}_{right} ) & ( 5 )\end{matrix}$$

Similarly the very small shaded area 1202 in FIG. 12b is obtained by the following:

$$Area [ Figure 12 b ] = ( \frac{{θ}_{left}}{2} \frac{1}{2 π} ) ( π {R}^{2} ) - \frac{1}{2} ( R cos ( \frac{{θ}_{left}}{2} ) ⋆ R sin ( \frac{{θ}_{left}}{2} ) ) \\ = \frac{{R}^{2}}{4} ( {θ}_{left} - sin {θ}_{left} ) \qquad \begin{matrix}( 6 ) \\ ( 7 )\end{matrix}$$

The shaded area 1203 in FIG. 12c is obtained by calculating the integral of an arbitrary function f(•). The shaded area equivalent to the area under the function f(•) from point x=x_{left} to x=x_{right} and is obtained by the following:

$${\int }_{{x}_{left}}^{{x}_{right}} f ( z ) d z \qquad ( 8 )$$

To find the point where ƒ(x_{right}) and the circular border of the aperture intersect, the following equation may be used.

[ƒ(x_{right})]²+[x_{right}]²=R² (9)

x_{right}²=R²−ƒ²(x_{right}) (10)

x_{right}=\sqrt{R²−[ƒ(x_{right})]²} (11)

Similarly, to find the point where ƒ(x_{left}) and the circular border of the aperture intersect, the following equation may be used.

[ƒ(x_{left})]²+[x_{left}]²=R² (12)

x_{left}²=R²−[ƒ(x_{left})]² (13)

x_{left}=\sqrt{R²−[ƒ(x_{left})]²} (14)

Returning to the cross-section calculation, combining all three areas illustrated in 12a-12c, exactly top half or bottom half of the hollow area of the cross-section in FIG. 10b is obtained. Specifically, this shaded area, as rendered in FIG. 13a, is the sum of three area components 1201,1202,1203:

$$\begin{matrix}\begin{matrix}Area [ Figure 13 a ] = Area [ Figure 12 a ] + Area [ Figure 12 b ] + \\ Area [ Figure 12 c ] \\ = \frac{{R}^{2}}{4} ( {θ}_{right} - sin {θ}_{right} ) + \frac{{R}^{2}}{4} ( {θ}_{left} - sin {θ}_{left} ) + \\ {\sum }_{{x}_{left}}^{{x}_{right}} \int f ( z ) d z\end{matrix} \\ where & ( 15 ) \\ {θ}_{left} = arc sin [ \frac{f ( {x}_{left} )}{R} ] & ( 16 ) \\ {θ}_{right} = arc sin [ \frac{f ( {x}_{right} )}{R} ] & ( 17 )\end{matrix}$$

To obtain the entire area of the cross-section in FIG. 10b, this aggregate sum is multiplied by 2 since there are mirror image areas 1201,1202,1203 to the calculated areas 1311,1312,1313. Thus the shaded area in FIG. 13b is given by:

Area [FIG. 13b]=2*Area [FIG. 13a] (18)

This calculates to be:

$$Area [ Figure 13 b ] = \frac{{R}^{2}}{4} ( {θ}_{right} - sin {θ}_{right} ) + \frac{{R}^{2}}{4} ( {θ}_{left} - sin {θ}_{left} ) + 2 {\int }_{{x}_{left}}^{{x}_{right}} f ( z ) d z \qquad ( 19 )$$

Alternatively, the area can be partitioned differently as shown in FIGS. 14a-14c. This shaded area 1401 in FIG. 14a is obtained by subtracting the area of triangle from the area of the semicircle of angle θ_{right} as follows:

$$\begin{matrix}Area [ Figure 14 a ] = \frac{{θ}_{right}}{2 π} π {R}^{2} - \frac{1}{2} ( 2 {R}^{2} sin \frac{{θ}_{right}}{2} ⋆ R cos \frac{{θ}_{right}}{2} ) & ( 20 ) \\ = \frac{{θ}_{right}}{2} {R}^{2} - {R}^{2} sin \frac{{θ}_{right}}{2} ⋆ cos \frac{{θ}_{right}}{2} & ( 21 )\end{matrix}$$

Using the double angle formula for sin:

sin 2θ=2 cos φ sin φ (22)

this reduces to

$$\begin{matrix}Area [ Figure 14 a ] = ( \frac{{θ}_{right}}{2} ) {R}^{2} - \frac{{R}^{2}}{2} sin {θ}_{right} & ( 23 ) \\ = \frac{{R}^{2}}{2} ( {θ}_{right} - sin {θ}_{right} ) & ( 24 )\end{matrix}$$

Similarly, the very small shaded area 1402 in FIG. 14b is calculated as follows:

$$\begin{matrix}Area ( Figure 14 b ) = \frac{{θ}_{left}}{2 π} π {R}^{2} - \frac{1}{2} ( 2 R sin \frac{{θ}_{left}}{2} ⋆ R cos \frac{{θ}_{left}}{2} ) & ( 25 ) \\ = \frac{{θ}_{left}}{2} {R}^{2} - {R}^{2} sin \frac{{θ}_{left}}{2} ⋆ cos \frac{{θ}_{left}}{2} & ( 26 ) \\ = ( \frac{{θ}_{left}}{2} ) {R}^{2} - \frac{{R}^{2}}{2} sin {θ}_{left} & ( 27 ) \\ = \frac{{R}^{2}}{2} ( {θ}_{left} - sin {θ}_{left} ) & ( 28 )\end{matrix}$$

The shaded area 1403 in FIG. 14c is obtained by using integral of an unknown function f(z) as mentioned earlier. The shaded area equivalent to the area under the function f(z) from x_{left} to x_{right} and is obtained by the following:

$$2 {\int }_{{x}_{lef} t}^{{x}_{right}} f ( z ) d z \qquad ( 29 )$$

Combining all three areas shown in FIGS. 14a-14c, the following is obtained:

$$Area [ Figure 12 a ] + Area [ Figure 12 b ] + Area [ Figure 12 c ] = [ \frac{{R}^{2}}{2} ( {θ}_{right} - sin {θ}_{right} ) ] + [ \frac{{R}^{2}}{2} ( {θ}_{left} - sin {θ}_{left} ) ] 2 {\int }_{{x}_{left}}^{{x}_{right}} f ( z ) d z \qquad ( 30 )$$

This is the same result as obtained in the previous calculation involving the method of FIGS. 12a-12c.

To determine the points where function f(z) and circle intersect, that is, the ordered pairs (x_{left}, ƒ(x_{left})) and (x_{right}, ƒ(x_{right})), the following equations could be used. Here the variable z is replaced by the function Z(•). This function Z(•) is a function of x*, where x* is on the circle centered at the origin with radius R. Its inverse, denoted Z⁻¹(•), is a function of R and θ. Then the values of x_{left} and x_{right} and θ at the points of intersection can be related as follows:

Z(x_{right})=R sin θ_{right} (31)

x_{right}=Z⁻¹(R sin θ_{right}) (32)

and

Z(x_{left})=R sin θ_{left} (33)

x_{left}=Z⁻¹(R sin θ_{left}) (34)

Alternatively, one can use coordinate conversions to rectangular coordinates to eliminate thetas used in the polar coordinate system and put all in terms of x_{right} and x_{left} in terms of rectangular coordinates, or visa versa. For the aperture representation depicted in FIGS. 12a-12c, let R=Rₐ in the following calculations so as to simplify notation. Then the relations for the left side of the aperture representation of FIGS. 12a-12c may be given by:

$$\begin{matrix}R = \sqrt{{x}_{left}^{2} + {y}_{left}^{2}} = \sqrt{{x}_{left}^{2} + {f ( {x}_{left} )}^{2}} & ( 35 ) \\ {x}_{left} = R cos {θ}_{left} = \sqrt{{R}^{2} - {f ( {x}_{left} )}^{2}} & ( 36 ) \\ f ( {x}_{left} ) = {y}_{left} = R sin {θ}_{left} = \sqrt{{R}^{2} - {x}_{left}^{2}} & ( 37 ) \\ {θ}_{left} = arc cos ( \frac{{x}_{left}}{R} ) & ( 38 ) \\ {θ}_{left} = arc sin ( \frac{f ( {x}_{left} )}{R} ) & ( 39 )\end{matrix}$$

while for the right side of the aperture representation of FIGS. 12a-12c, the relations are:

$$\begin{matrix}R = \sqrt{{x}_{right}^{2} + {y}_{right}^{2}} = \sqrt{{x}_{right}^{2} + {f ( {x}_{right} )}^{2}} & ( 40 ) \\ {x}_{right} = R cos {θ}_{right} = \sqrt{{R}^{2} - {f ( {x}_{right} )}^{2}} & ( 41 ) \\ f ( {x}_{right} ) = {y}_{right} = R sin {θ}_{right} = \sqrt{{R}^{2} - {x}_{right}^{2}} & ( 42 ) \\ {θ}_{right} = arc cos ( \frac{{x}_{right}}{R} ) & ( 43 ) \\ {θ}_{right} = arc sin ( \frac{f ( {x}_{right} )}{R} ) & ( 44 )\end{matrix}$$

These can be used to construct various integral representations such as the following:

Case 1: In Terms of x's

$$\frac{{R}^{2}}{2} [ arc cos [ \frac{{x}_{right}}{R} ] - \frac{\sqrt{{R}^{2} - {x}_{right}^{2}}}{R} + arc cos [ \frac{{x}_{left}}{R} ] - \frac{\sqrt{{R}^{2} - {x}_{left}^{2}}}{R} ] + 2 {\int }_{{x}_{lef} t}^{{x}_{right}} f ( z ) d z \qquad ( 45 )$$

Case 2: In Terms of f(x)'s

$$\frac{{R}^{2}}{2} [ arc sin [ \frac{{f ( x )}_{left}}{R} ] - \frac{f ( {x}_{right} )}{R} + arc sin [ \frac{f ( {x}_{left} )}{R} ] - \frac{f ( {x}_{left} )}{R} ] + 2 {\int }_{\sqrt{{R}^{2} - {f ( {x}_{left} )}^{2}}}^{\sqrt{{R}^{2} - {f ( {x}_{right} )}^{2}}} f ( z ) d z \qquad ( 46 )$$

Case 3: In Terms of θ's

$$[ \frac{{R}^{2}}{2} ( {θ}_{right} - sin {θ}_{right} ) ] + [ \frac{{R}^{2}}{2} ( {θ}_{left} - sin {θ}_{left} ) ] + 2 {\int }_{rcos {θ}_{right}}^{rcos {θ}_{right}} f ( z ) d z \qquad ( 47 )$$

as well as other representations as is clear to one skilled in the art. These may later be used to form integral equations that may be used to solve for a desired unknown function f(x) defining the shape of the passageway. In these types of equations, typically the desired unknown function f(x) in one form or another appears in or influences the limits of integration to form a functional equation similar to a Volterra integral equation.

### Projective Geometry Transformations Between Aperture View and Rotary Element Surface

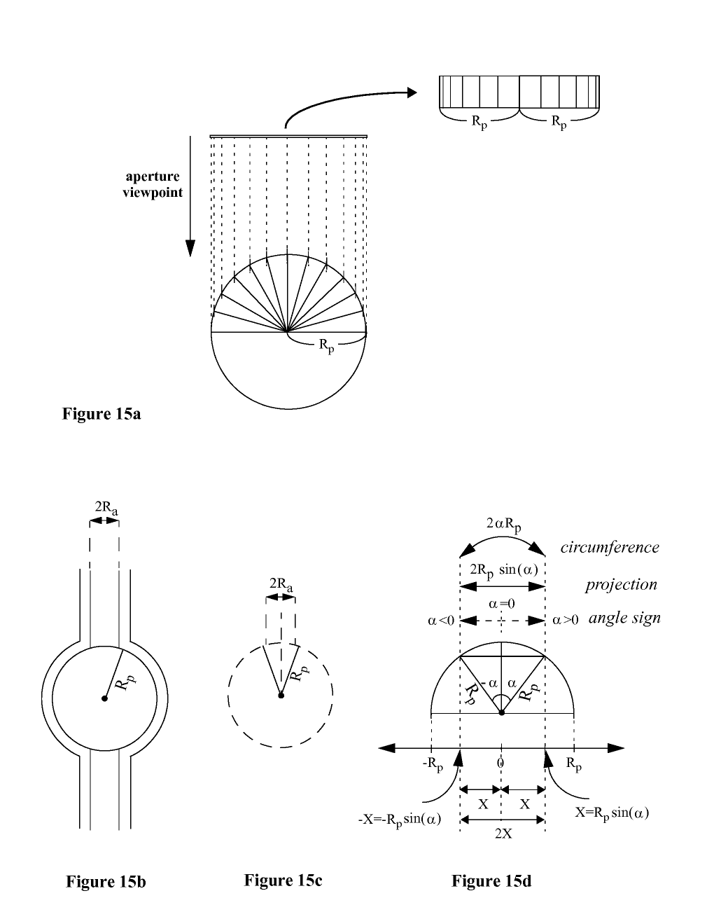

FIG. 15a illustrates the geometric projection transformation of a linear rule laid out over the arc length of a rotary element into the geometry as seen from the aperture view point. The variation between the local arc length and local projection length depends on the vertical position along the circumference (which is equivalent to the x coordinate of the aperture view afore described) as is defined by a sine-function mapping.

FIG. 15b illustrates the aperture radius Rₐ and plug radius Rₚ in terms of the stopcock example depicted in FIGS. 1a-1e, and FIG. 10a. FIG. 15c illustrates the sector of the plug of FIG. 15b that is exposed within the aperture of radius Rₐ.

In particular, FIG. 15d illustrates the relationship between the arc length and the length in projection. When the valve is turned a radians away from the center of the view point, assuming the center of the semicircle is aligned with the center of the view point, the arc length is equivalent to the following:

$$Arc length = \frac{2 α}{2 π} 2 π R = 2 α R \qquad ( 48 )$$

where R is the inner diameter of the plug and a is the angle (in radians) of plug (or ball) element rotation. The length of the projection is:

Projection of Arc length=2R sin α (49)

Then the ratio between the arc length and projected length is thus (again with α measured in radians):

$$\frac{ArcLength}{ProjectedArcLength} = \frac{2 α R}{2 R sin α} . \qquad ( 50 )$$

This simplifies to:

$$\frac{α}{sin α} \qquad ( 51 )$$

Let X represent the projected length. When the angle α, specified in radians, is changed, the length in the projection X is changed according to sin α.

$$\begin{matrix}\frac{α}{{R}_{p}} = arcsin ( \frac{X}{{R}_{p}} ) & ( 52 ) \\ α = {R}_{p} arcsin ( \frac{X}{{R}_{p}} ) & ( 53 ) \\ ( \frac{X}{{R}_{p}} ) = sin ( \frac{α}{{R}_{p}} ) & ( 54 )\end{matrix}$$

As shown in FIG. 15d, as the angle α is varied from 0 to

$$\frac{π}{2} ,$$

the projected length x varies from 0 to Rₚ. Similarly, as the angle α is varied from 0 to

$$- \frac{π}{2} ,$$

the projected length X varies from 0 to −Rₚ. Since the projected length of angle α or angle −α, the projected length will be equivalent to 2X. Let

$$sin ( α ) = \frac{X}{{R}_{p}} \qquad ( 55 )$$

then

X=Rₚ sin(α) (56)

or

2X=Rₚ sin(α) (57)

For negative angles

$$\begin{matrix}sin ( - α ) = \frac{- X}{{R}_{p}} & ( 58 ) \\ - X = {R}_{p} sin ( - α ) & ( 59 )\end{matrix}$$

FIG. 16 illustrates how an opening cut into a surface generates different shapes in projected view depending on whether the surface is flat or is curved. This warp effect was discussed earlier in the case of a rotating plug or ball element in the material associated with FIG. 13a. As an example, an isosceles triangle shaped guiding sheet was rolled around on the barrel of a plug valve element as shown in FIG. 16. Here the tip of the triangle is vertically centered. The drawing on the left side of FIG. 16 represents when this shape template in projected onto a parallel plane. The drawing on the left side of FIG. 16 represents when this shape template in projected onto a convexly-curved surface. The tip of the triangle, or the upper part of the two equal sides appear as straight lines but appear more curved at points increasingly farther away from the vertical center. The sides of the projection of the isosceles triangle appear slightly curved and as it approaches the vertical center, then appears locally increasingly straight, then becomes curved again farther from the vertical center in the opposite direction. Note in the described arrangement, the effective height of the triangular shape is reduced by the projective warping effect.

The isosceles triangle is curved along the side of the cylinder vertically, so the top and bottom of the triangle is farther than the vertical center of the triangle which makes that region appear smaller. If the orientation of the triangle is rotated 90 degrees clockwise or counter-clockwise, the warp effect will take place horizontally instead of vertically, which will place more warp effect farther left or right side away from the center.

FIGS. 17a-17c illustrate views from the side of the stopcock valve as the angle of the operating handle varies. The bold curve represents the position of the circumferential opening on one side of the passageway.

FIGS. 18a-18c illustrate views from the top of the stopcock valve as the angle of the handle turned varies, each respectively corresponding to the handle positions depicted in FIGS. 17a-17c. The convexity of the curve could be such that one or both of the rotational angle extremes of the passageway could come to a point as depicted in the example of FIG. 16, or may be rounded as depicted in the example of FIGS. 18a-18c.

### Fundamental Limits to Rotational Span of Passageway

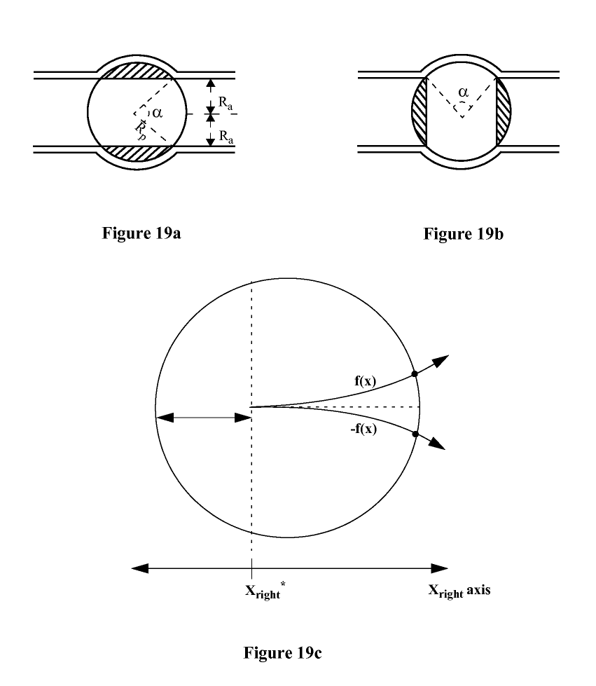

FIGS. 19a and 19b illustrate, respectively, cases when the rotary valve is completely opened and completely closed, useful in determining maximum span of the passageway through the rotary element.

In order for the valve to completely stop the flow, the diameter of the hollow volume needs to be greater or equal to the diameter D=2 Rₐ of inner tube or the flow path. This is expressed in the following equation:

$$\begin{matrix}2 {R}_{p} [ sin ( \frac{α}{2} ) ] \geq D = 2 {R}_{a} & ( 60 ) \\ {R}_{p} s ( \frac{α}{2} ) \geq {R}_{a} & ( 61 ) \\ sin ( \frac{α}{2} ) \geq \frac{{R}_{a}}{{R}_{p}} & ( 62 ) \\ arcsin ( \frac{{R}_{a}}{{R}_{p}} ) \geq \frac{α}{2} & ( 63 ) \\ 2 arcsin ( \frac{{R}_{a}}{{R}_{p}} ) \geq α . & ( 64 )\end{matrix}$$

FIG. 19c illustrates an aperture viewpoint for a case of a partially-open rotary valve in accordance with the invention. Note the quantity xᵣ* defines the location in the angular rotation direction of the aperture coordinate system where the passageway closes. In the depicted example, the convexity of f(x) is such that the passageway closes in a point. In other embodiments, the convexity of f(x) may be such that the passageway closes in a curve.

### Integral Equation for Arbitrary Flow Response to Angular Position

The cross sectional area for a given circumferential passageway boundary curve as positioned by the handle is calculated as:

$$\frac{{R}^{2}}{2} ( {θ}_{right} - sin {θ}_{right} ) + \frac{{R}^{2}}{2} ( {θ}_{left} - sin {θ}_{left} ) + 2 {\int }_{{x}_{left}}^{{x}_{right}} f [ R * arcsin ( \frac{x}{R} + τ ) ] d x \qquad ( 65 )$$

where τ is the rotation offset from the handle. This can be equated, within a multiplicative constant, to a desired angular flow function g(τ). This results in an integral equation for determining circumferential passageway boundary curve ƒ(•) for a specified angle-determined flow function h(τ)

$$h ( τ ) = c \{ \frac{{R}^{2}}{2} ( {θ}_{right} - sin {θ}_{right} ) + \frac{{R}^{2}}{2} ( {θ}_{left} - sin {θ}_{left} ) + 2 {\int }_{{x}_{left}}^{{x}_{right}} f [ R * arcsin ( \frac{x}{R} + τ ) ] d x \} \qquad ( 66 )$$

Here the multiplicative constant c is introduced to match the normalization of the angle-determined flow function h(τ) on the left-hand side of the equation with the flow scale as inherently normalized in the right-hand side of the equation.

The resultant integral equation is solved for the function f. Since X_{left}, X_{right}, and f(*) are all interdependent, the equation is sufficiently complicated that numerical solution by computer is typically required. Further, although it is possible to use sine and arcsine functions to put all angle variables in terms of X_{left}, X_{right}, the resultant integral equation is still extremely complex, daunting for both attempts to solve or approximate solutions for either analytically in closed form (if even possible) or numerically.

### Strategizing Numerical Solution Approaches

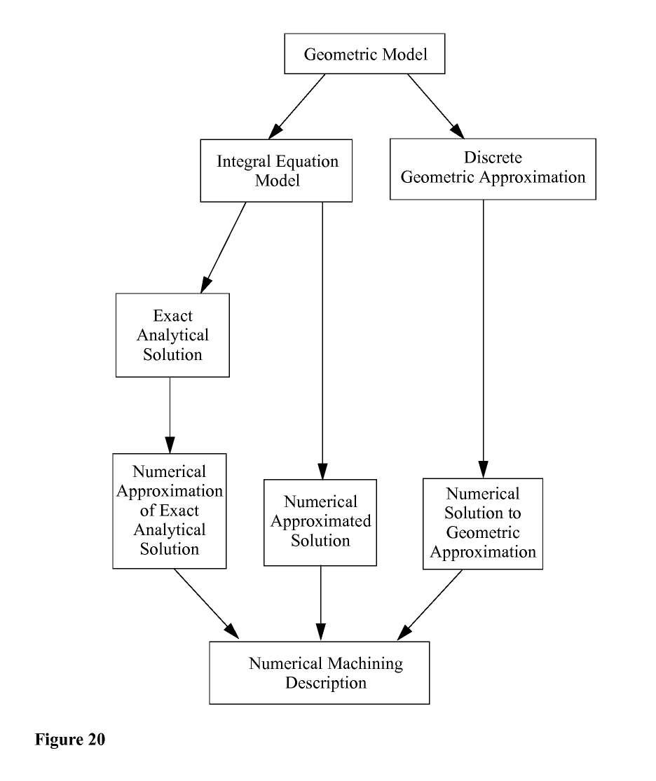

FIG. 20 depicts several approaches to finding the solution to the type of geometric and mathematical problems posed above. In each approach, a geometric model is used. The group of approaches on the left column of FIG. 20 each begin with the analytic formulation of an integral equation. In some cases, with luck and skill the integral equation may be solved to obtain an exact analytical solution. Even then a numerical approximation to the exact solution must be employed to create numerical machining descriptions needed for manufacture of the rotating plug or ball element.

Given the demonstrated complexities of the integral equations involved and the ultimate numerical form eventually required for manufacturing, an earlier-stage numerical approach to finding the f(x) function to define passageway shape seems appropriate. One approach would be to numerically solve the modeling integral equations (as depicted in the center path of FIG. 20). This could be done by various well-known numerical means for solving these types of integral equations. Nonetheless, this task is still potentially formidable and can, with out the proper tools, require significant mathematical background. There may also be issues of numerical stability and convergence in some iterative algorithmic formulations. Alternatively, discrete formulation may be made directly from the geometry. As will be shown, this discrete formulation leads immediately to simple well-defined linear algebraic equations which are readily solved by analytic methods, numerical matrix inversion, or other classic numerical linear algebraic methods.

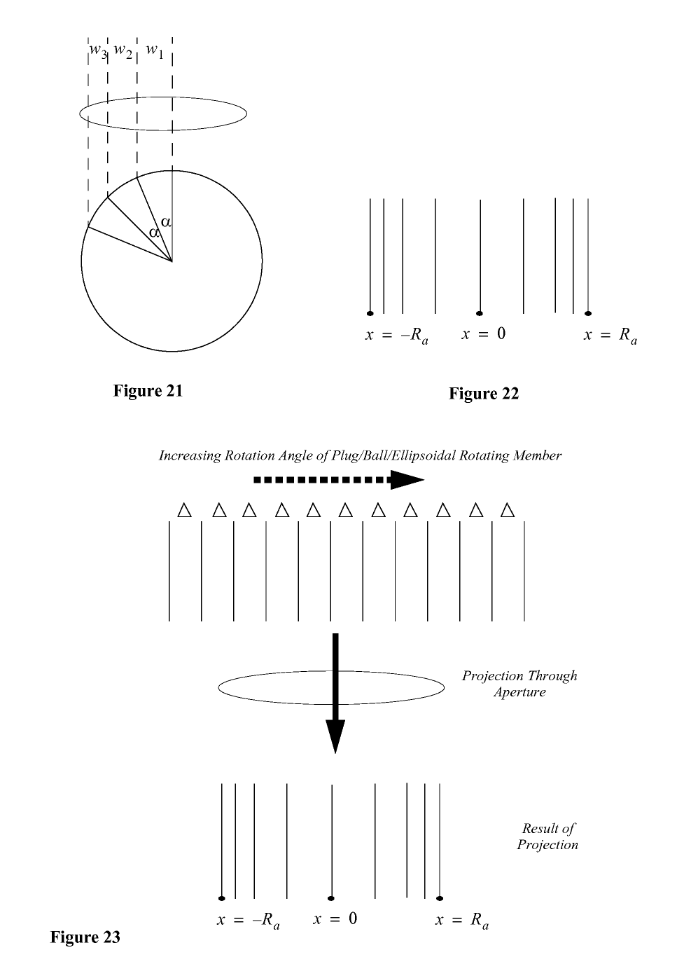

FIG. 21 depicts, as projected into the aperture view (and hence as experienced as cross-sectional area by the flow path) a uniform circumferential lattice. as projected into the aperture view (and hence as experienced as cross-sectional area by the flow path), each uniformly spaced step along the circumference of the plug is seen as a progressively smaller step-size on either side of the center of the aperture view. This step-size variation results from sine-function mapping induced by the projection from the curved surface. Such a projection effect also occurs for the same reasons with spherical rotating members (i.e., as in ball valves) and ellipsoidal rotating members. FIG. 22 depicts the step-size variation results from sine-function mapping induced by the projection from the curved surface in more detail for an example uniform step-size along the circumference of the plug/ball/ellipsoid rotating member. Here the horizontal distance ranges from a value of negative the aperture radius to a value of positive the aperture radius with a zero value in the center. The resultant twice-radius distance corresponds to the diameter (i.e., width) of the aperture.

FIG. 23 shows another representation of step-size variation as a function of rotation direction for a regular circumferential lattice as projected into the aperture view (and hence flow path) resulting from sine-function mapping induced by the projection from the curved surface. A discrete-domain function defined on the uniform spacing would be warped through this projection effect in various ways (squeezed, then nearly exact, then squeezed again) as the rotation angle of the plug/ball/ellipsoid rotating member is monotonically changed.

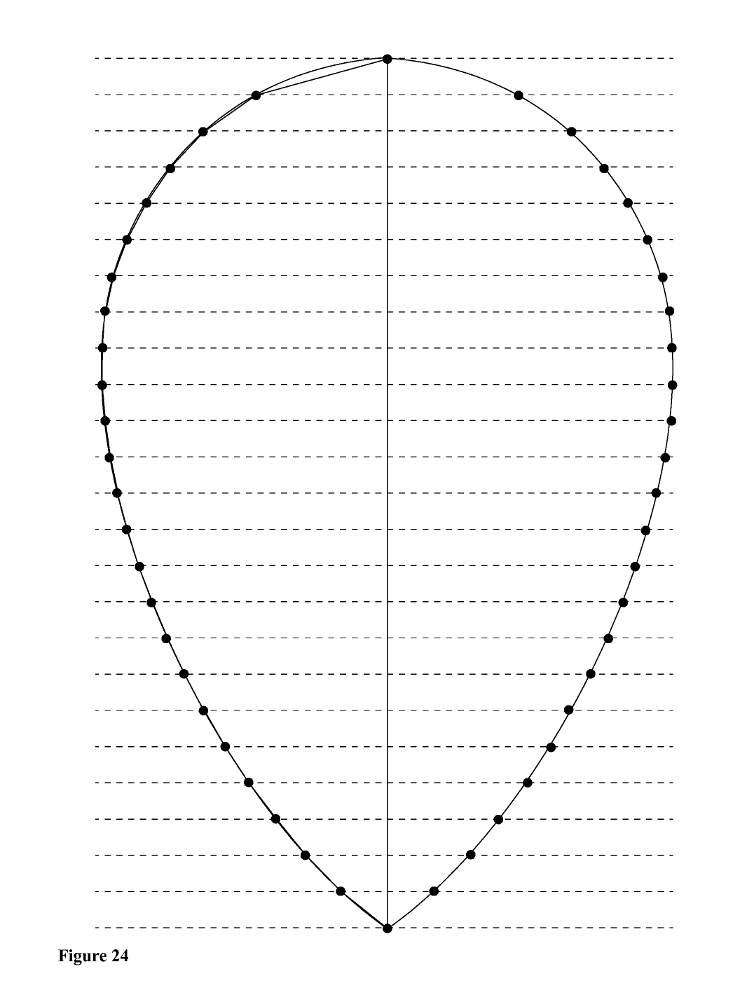

FIG. 24 depicts an example passageway opening whose boundary is sampled at uniform step spacing along the plug/ball/ellipsoid rotating member circumference. In manufacturing the shape may be rendered as a smooth curve. In a computer or discrete math representation, the shape can be regarded as piecewise linear. If the uniform step spacing is fine enough, the piecewise linear approximation can get very close to the smoothed curve as seen in the upper left portion of the figure, deviating from the smooth curve noticeably when the radius of curvature of the smooth curve grows small (an example of which can be seen in the first step to the left of the centerline at the top of the figure).

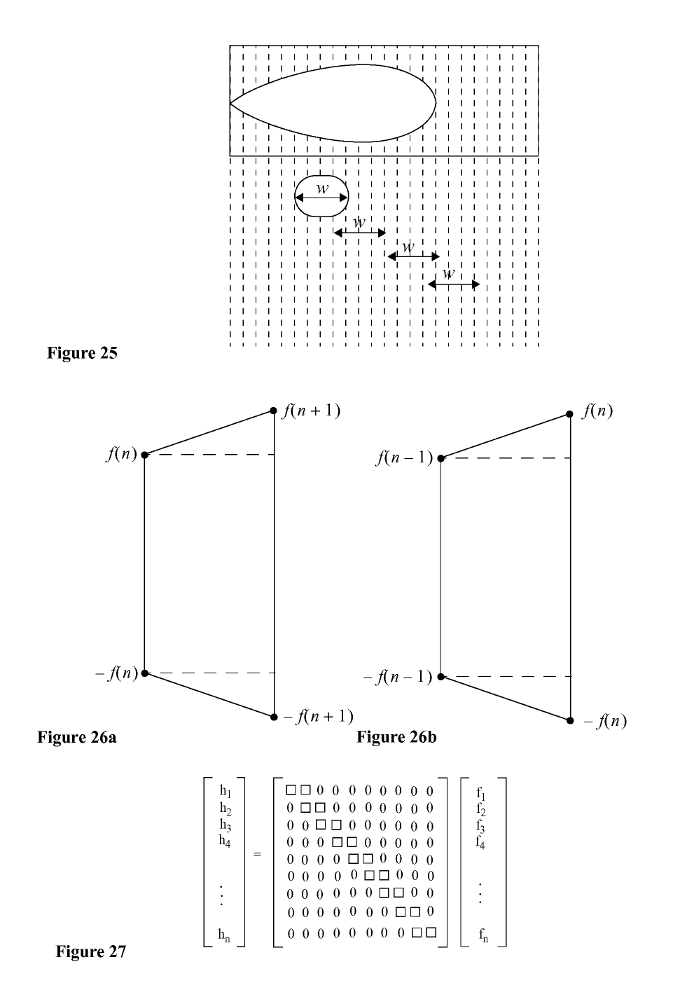

FIG. 25 depicts the uniformly sampled passageway opening extended over half the plug/ball/ellipsoid rotating member circumference. The other half of the circumference is the projection of FIG. 25 through to the other side of the rotating member. The aperture diameter as projected onto the curved circumferential surface of the plug/ball/ellipsoid rotating member is dilated to a broader width denoted as w in FIG. 25. A representation of the projected aperture shape (warped into an ellipse due to the sine projection) is shown then in FIG. 25 as an ellipse with major axis w. In the case of a plug rotating member, the minor axis of the ellipse in FIG. 25 representing the aperture will be the diameter of the aperture as there is no curvature of the minor axis and thus no sine projection effect. In the case of a ball rotating member, the minor axis of the ellipse in FIG. 25 representing the aperture will also be w of the aperture as there is the same curvature in the minor axis direction as there is in the major axis direction, and thus the very same sine projection effect is induced. In the case of an ellipsoid (or other type of shape) rotating member, the minor axis will be some other expression defied by the geometry of the cross sectional curve in the direction of the minor axis. In some cases, the cross sectional curve ellipsoid (or other type of shape) can be such that the formal roles of major and minor axes are reversed and in such cases w would represent the minor axis.

Continuing with FIG. 25, as the rotating member is rotated within the valve, the location of the aperture with respect to the opening of course changes. In FIG. 25 additional double-arrows of width w are shown, each representing the major-axis span. These double-arrows are vertically displaced only so as to depict a sequence of overlapping aperture locations. In one interpretation, the vertical position of these double-arrows represents a value in time as the rotating member is continuously rotated over time in a direction so as to cause the depicted half-circumference section to move to the left in FIG. 25.

FIGS. 26a and 26b depicts example trapezoid comprised by geometric arrangements such as that depicted in FIG. 24 and its incorporation into FIG. 25. These trapezoids (and variations on them, such as those with interpolated heights) are similar to the ones used in the “Trapezoidal Rule” and “Simpson's Rule” in integral calculus and can accordingly be used to approximate the area of the opening exposed through the aperture. If the uniform step size is an integral-divisor-of-unity fraction (⅕, 1/10, 1/25, etc.), then as the aperture view is moved one step at a time along the horizontal axis of FIG. 25, a uniform series of mathematical equations result. This is because the warping geometry sampling positions are fixed and effectively simply imposed a varied width on the trapezoids. The resultant form has the structure of a discrete (linear) convolution:

$$h ( n ) = {\sum }_{α} f ( k ) aperature ( n - k ) \qquad ( 67 )$$

If the aperture were rectangular or square (rather than round) the result would in fact be such a convolution. Such a convolution can be represented as a band-matrix; FIG. 27 depicts a vector and band-matrix equation that can be formulated from a collection of trapezoids such as those of FIG. 26 that are in turn comprised by geometric arrangements such as that depicted in FIGS. 24 and 25.

However, for a circular aperture, the aperture imposes a “ceiling” on the available cross-sectional area. This imposes a “maximum” function, resulting in the following form of nonlinear discrete convolutional equation:

$$h ( n ) = {\sum }_{α} Max [ f ( n ) , circle ( n ) ] aperature ( n - k ) \qquad ( 68 )$$

The solution to this can be approximated by starting with a small scaling factor to scale down the initial values of the desired angular flow response and then proceed with the solution to the linear convolutional equation provided above (for example, solving the band-matrix equation depicted in FIG. 27). Iterative methods can be used to redistribute some of the area over the various values of rotation angle until the desired flow rate can be scaled up to the desired value.

### Introduction of Compensation for Turbulence Effects

The integral equation described earlier can be augmented with a term representing turbulence. Typically this term would be a functional depending on both F(X) and τ.

$$h ( τ ) = c \{ T ( f , τ ) + \frac{{R}^{2}}{2} ( {θ}_{r} - sin {θ}_{r} ) + \frac{{R}^{2}}{2} ( {θ}_{l} - sin {θ}_{l} ) + 2 {\int }_{{x}_{l}}^{{x}_{r}} f [ R * arcsin ( \frac{x}{R} + τ ) ] d x \} \qquad ( 69 )$$

Similar terms can be included in the linear and nonlinear convolution equations presented above. Iterative numerical techniques can then be used to modify the solutions of the convolution equations in a similar fashion:
First start with a small scaling factor to scale down the effect of the added turbulence terms;
Next, proceed with the solution to the slightly-offset convolutional equations provided above;
Iterative methods can be used to redistribute some of the area over the various values of rotation angle until the turbulence term is scaled up to full unattenuated value.

### Servo or Motorized Operation of Valves for Laboratory Automation and Other Applications

The above arrangements can be employed in larger arrangements providing electrically controlled valves so as to reliably control the transport flows in of, out of, and among vessels. These can be in turn used in creating automated environments employing conventional laboratory glassware, for example under the control of a computer.

The invention provides for servo or motorized operation of valves for laboratory automation and other applications. These are designed to work with existing laboratory glassware without modification to that glassware.

A first group of approaches involve clamping to the glassware. These can be expected to experience mechanical hysteresis and may require ongoing tightening maintenance.

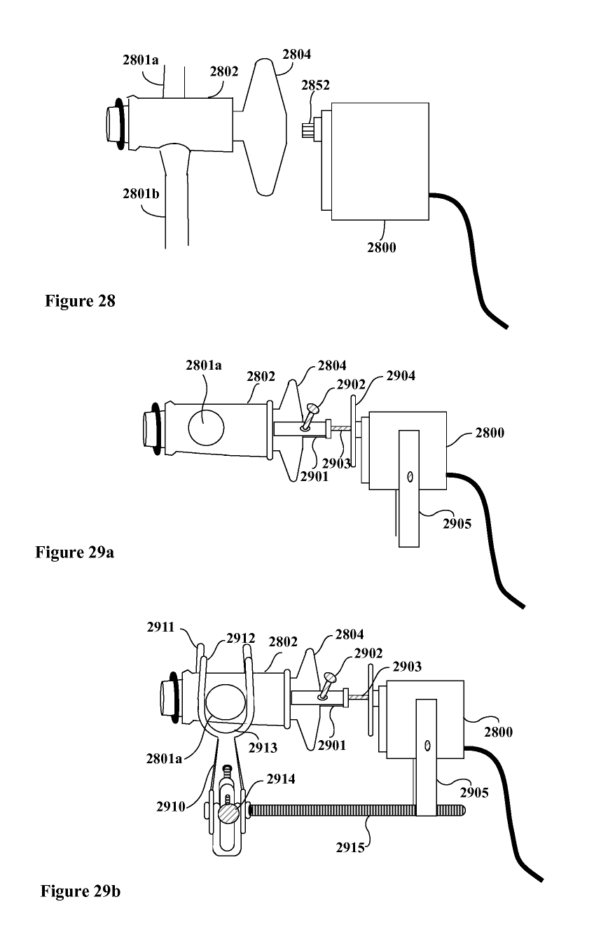

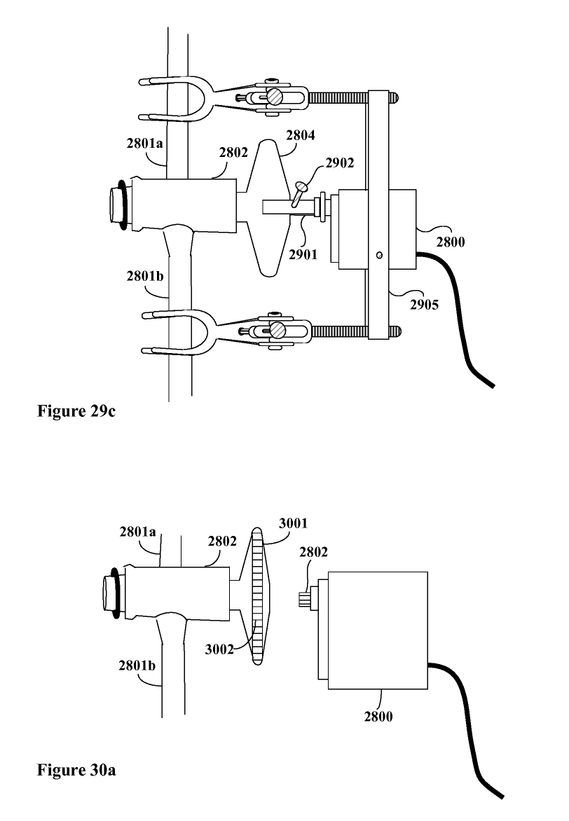

FIG. 28 illustrates the generic situation wherein the handle 2804 of a stopcock body 2802 can be coupled to the rotational shaft 2852 of a servo motor, stepper motor, or other angular actuator 2800. In one approach, the servo motor, stepper motor, or other angular actuator 2800 can be secured via clamps to the stopcock body near where it is joined by the glass tubing ports 2801a, 2801b. The rotational shaft 2852 of a servo motor, stepper motor, or other angular actuator 2800 can be clamped to the handle 2804 of a stopcock 2802. FIG. 29a illustrates an example of this wherein a transverse direct linkage 2903 is provided between a clamp 2901 with jaw position adjustment 2902 set to grip the traditional stopcock handle 2804 and the rotational shaft 2852 of the servo motor, stepper motor, or other angular actuator 2800 with supporting bracket 2905. FIG. 29b illustrates a view of an exemplary mounting arrangement for the configuration of FIG. 29a wherein the supporting bracket 2905 is attached to a support rod 2915 which in turn is adjustably supported by clamping arrangement 2914 with forked grip elements 2911, 2912 for gripping the stopcock body 2802 near where it is joined by the glass tubing ports 2801a, 2801b. FIG. 29c illustrates a 90-degree side view of the mounting arrangement shown in FIG. 29b. In an embodiment, the rotational coupling can include an optional external epicyclic (“planetary”) gearing arrangement 2904. Such an arrangement can be expected to experience mechanical hysteresis and may require ongoing tightening maintenance.

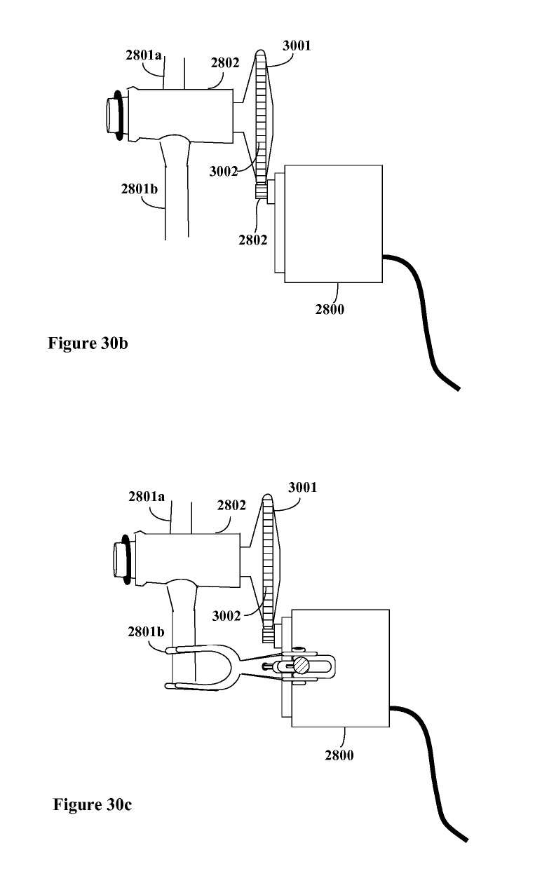

FIG. 30a illustrates the generic situation where a stopcock can be rotationally coupled to the geared rotating shaft 2802 a servo motor, stepper motor, or other angular actuator via a geared arrangement 2800. Here the stopcock plug handle 2804 has been replaced with a geared member 3001 with teeth 3002 matching that of the geared rotating shaft 2802. FIG. 30b illustrates the resultant example geared linkage between a traditional stopcock handle and a servo motor, stepper motor, or other angular actuator. FIG. 30c illustrates a mounting arrangement, including a clamp to the glass tubing, for the configuration of FIG. 30b. Such an arrangement can be expected to experience mechanical hysteresis and may require ongoing tightening maintenance.

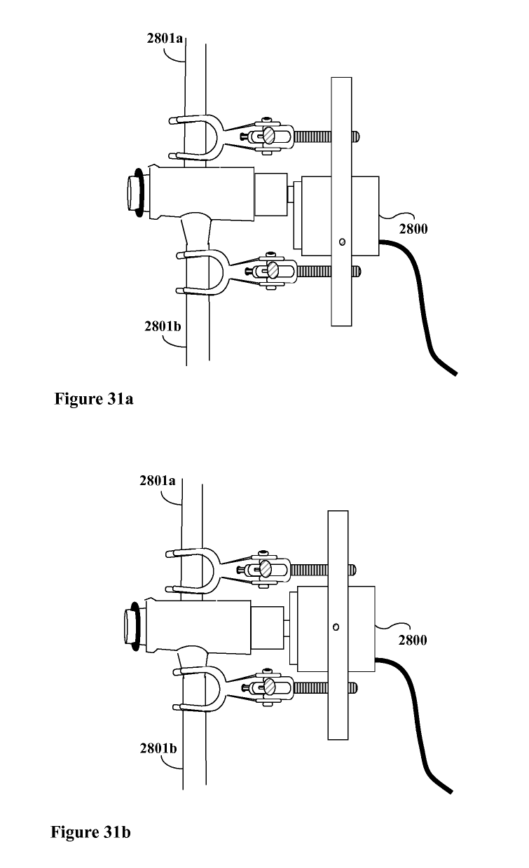

FIG. 31a illustrates a direct linkage between the stopcock element and a servo motor, stepper motor, or other angular actuator with an off-center drive shaft, along with a mounting arrangement. In this arrangement, a suitably modified stopcock plug element includes direct rotational coupling to a servo motor, stepper motor, or other angular actuator 2800. A traditional gear-train gearing arrangement can be used, which in many cases can result in the off-center position of the motor rotating shaft as shown in this and in the previous figures. In an alternate approach, the servo motor, stepper motor, or other angular actuator 2800 can employ an epicyclic (“planetary”) or folded gear-train so as to center the rotational drive shaft emanating from the servo motor, stepper motor, or other angular actuator 2800.

FIG. 31b illustrates a direct linkage between the stopcock element and a servo motor, stepper motor, or other angular actuator with a centered drive shaft, along with a mounting arrangement. Such an arrangement can be expected to experience mechanical hysteresis and may require ongoing tightening maintenance.

In that all the clamping arrangement can be expected to experience mechanical hysteresis and may require ongoing tightening maintenance, a better solution is desirable, especially in order to obtain reliable, predictable, and reproducible adjustments. A second exemplary approach to adding servo or motor control to the angle of rotation of the plug in a laboratory stopcock, particularly for including rotating stopcock plug elements with increased usable rotation angle plugs involves implementing a second interior rotatable plug structure within the stopcock plug itself, creating a concentric rotating plug hierarchy. This rotating plug hierarchy in turn can be inserted into the glassware stopcock encasement. The inner plug can be rotated by servo or motor, while the outer plug can be rotated by hand. Additionally, a handle can be attached to permit traditional hand-operation of the stopcock. Importantly, the resulting arrangement does not experience mechanical hysteresis nor require ongoing tightening maintenance in order to obtain reliable, predictable, and reproducible adjustments.

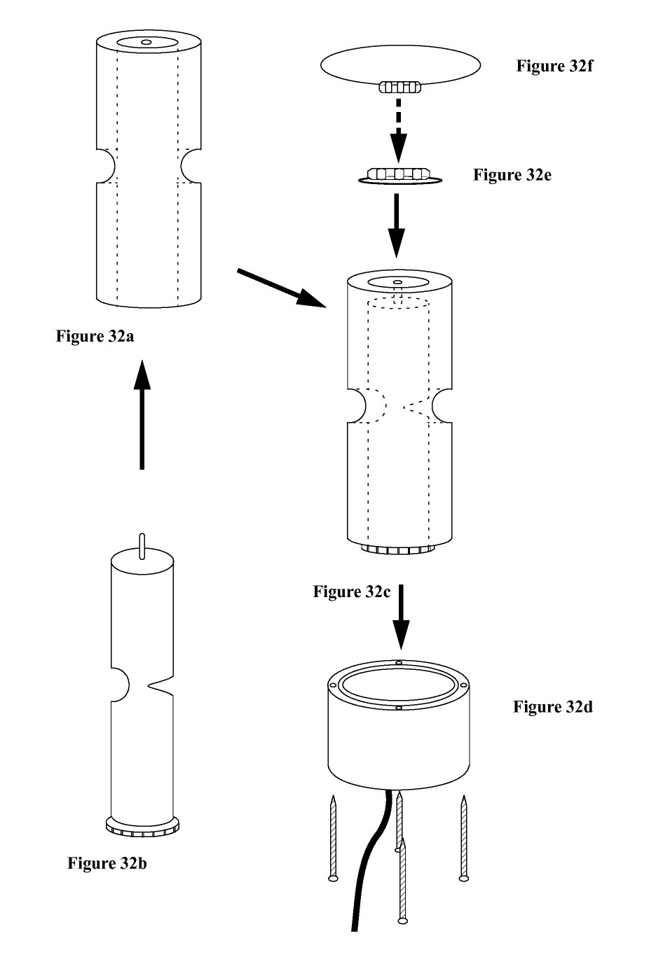

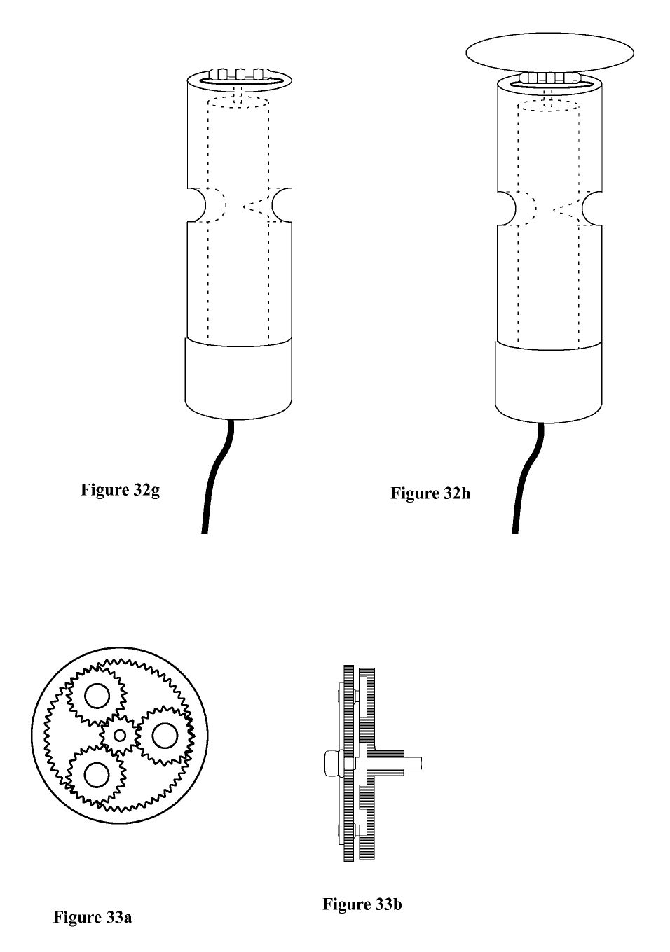

FIGS. 32a-32e illustrates a first approach wherein a stopcock plug internally comprises a movable element that can be controlled by a servo or motor element. FIG. 32a depicts and exemplary plug body, akin to that of the plug body 114 in FIGS. 1d-1e, plug body 414 in FIG. 4b, and plug body 514 in FIGS. 5c-5e. The plug body here, however, internally comprises a coaxial hollow cylindrical opening in which a smaller cylindrical plug, such as that depicted in 32b, can be inserted. In an embodiment, smaller cylindrical plug comprises the elongated openings, at least one rotational bearing or shaft, and at least one drive coupling or gear. The smaller cylindrical plug element can designed according to the general aspects of the invention described above. The combination of the exemplary hollow plug body and the smaller cylindrical plug is depicted in FIG. 32c and is arranged so that the combination can be inserted in the conical or cylindrical cavity 104 of a stopcock. The resulting arrangement allows for the control of flow through a conventional stopcock comprised by conventional glassware by two means: rotation of the hollow plug body (depicted in FIG. 32a) within the conical or cylindrical cavity 104 of a stopcock, and rotation of the smaller cylindrical plug (depicted in FIG. 32b) within the hollow plug body (depicted in FIG. 32a).

As described below, each of these rotations can be performed by one or both of manual operation (via a handle) and motorized operation via an electrical motor attachment such as that depicted in FIG. 32d.

A traditional stopcock end-fastener (such as a spring clip) can be used to hold the motor controlled stopcock plug in place within the stopcock glassware encasement. Additionally, a handle can be attached to permit traditional hand-operation of the stopcock.

In an implementation a cap, such as depicted in FIG. 32e, can be used to terminate one end of the combination depicted in FIG. 32c. In an embodiment, the cap can include a groove for accepting a securing grommet, elastic ring, or clip such as the one 112 depicted in FIG. 1a. In another embodiment, the cap can attach to a handle such as that depicted in FIG. 32f. In another embodiment, the cap can itself comprise a handle such as that depicted in FIG. 32f.

If provided, the handle can be used to manually rotate by hand the hollow plug body (depicted in FIG. 32a) within the conical or cylindrical cavity 104 of a stopcock. In another embodiment, the handle can be used to manually rotate by hand the smaller cylindrical plug (depicted in FIG. 32b) within the hollow plug body (depicted in FIG. 32a). In another embodiment, the handle can comprise two separately rotatable coaxial sections, one of which via mechanical connection can be used to manually rotate by hand the smaller cylindrical plug (depicted in FIG. 32b) and the other of which via mechanical connection can be used to manually rotate by hand the hollow plug body (depicted in FIG. 32a). In another embodiment, the handle can comprise two longitudinally-selectable positions (i.e., a push-pull selection), one position of which via mechanical connection can be used to manually rotate by hand the smaller cylindrical plug (depicted in FIG. 32b) and the other of which via mechanical connection can be used to manually rotate by hand the hollow plug body (depicted in FIG. 32a).

In an embodiment, an electrical motor attachment such as that depicted in FIG. 32d can be secured to the combination (of the hollow plug body and the smaller cylindrical plug) depicted in FIG. 32c via fasteners so as to create an electrically powered plug module such as those depicted in FIG. 32g (without hand-operated rotational handle) or FIG. 32h (with hand-operated rotational handle). The electrical motor attachment comprises a power and/or control cable; in an embodiment, such a cable is flexible enough to readily permit rotation of the electrical motor attachment within the conical or cylindrical cavity 104 of a stopcock.

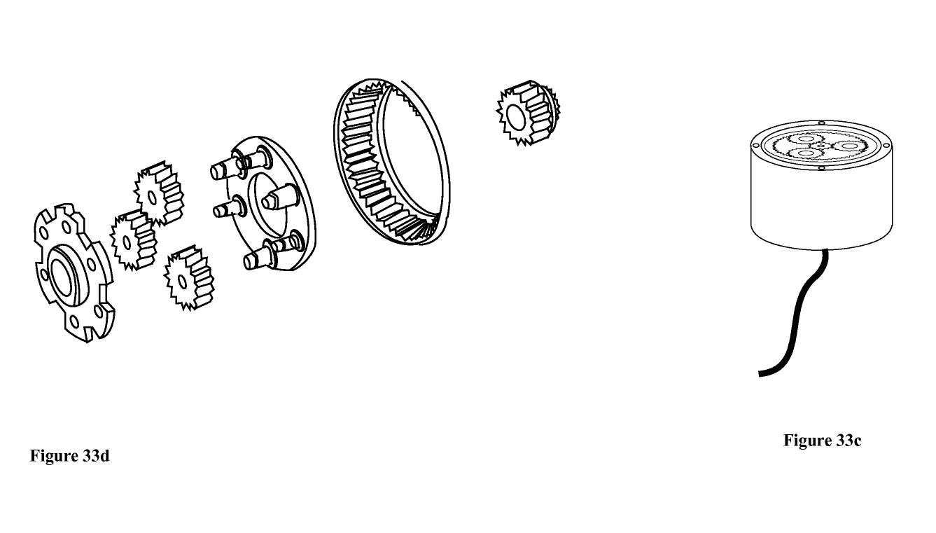

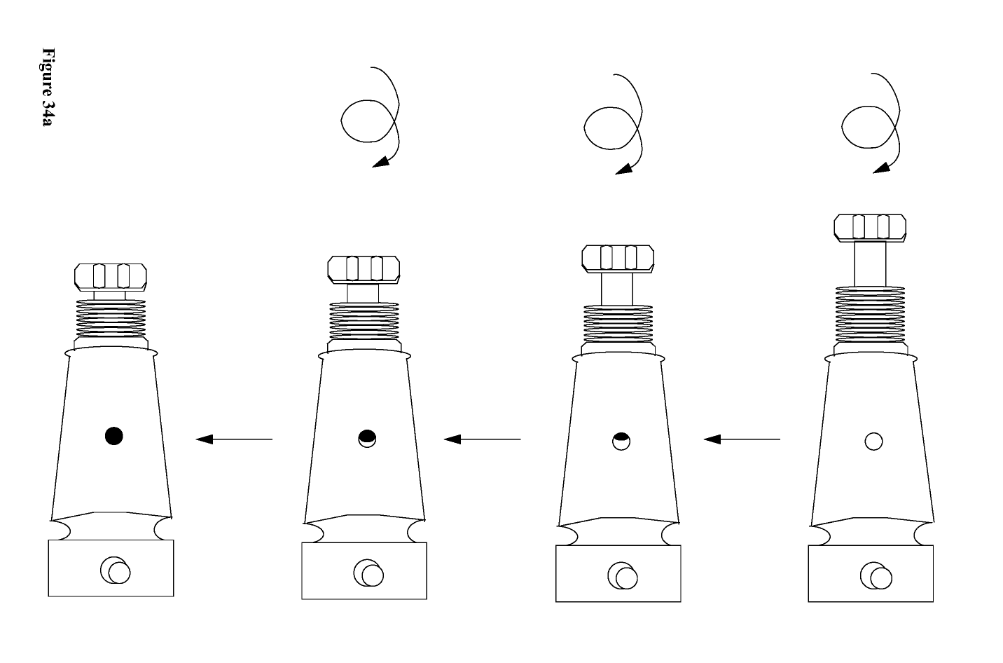

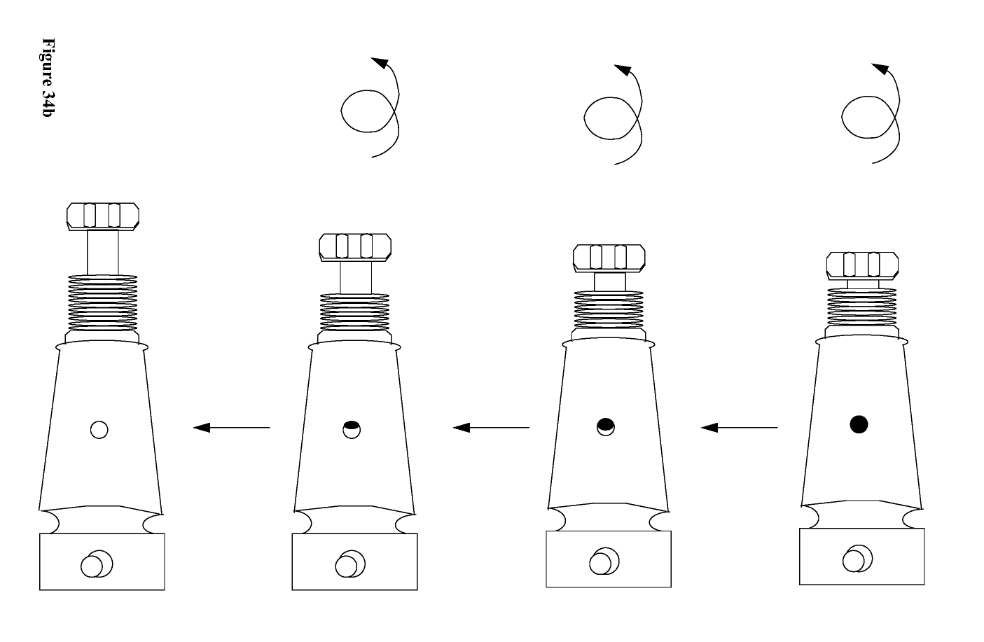

The electrical motor attachment depicted in FIG. 32d can comprise a servo-motor, stepper motor, conventional DC motor, etc. In some embodiments, a motor shaft or other rotational mechanical element directly or indirectly driven by the servo-motor, stepper motor, conventional DC motor, etc. can be outfitted with position sensing. In an implementation, the electrical motor attachment comprises a gear arrangement linking the servo-motor, stepper motor, conventional DC motor, etc. with a rotation element within the hollow plug body (depicted in FIG. 32a), for example the smaller cylindrical plug (depicted in FIG. 32b) or other structures such as an further example to be described later. In an implementation, the gear arrangement comprises an epicyclic gear arrangement. FIG. 33a shows the front view of an exemplary epicyclic (“planetary”) gear arrangement. Use of an epicyclic (or “planetary”) gear arrangement to link the motor and rotating elements within the plug body provides many advantages including:
Small compact size (FIG. 33b depicts an exemplary size view, demonstrating the remarkable degree of “flatness” of the gear arrangement);
Capability of providing high-torque output;
Range of effective (input-output) gear ratios;
High efficiency (work losses typically ˜3-5% per planetary stage);
Exceptional load distribution among components;
Greater operational stability and resulting smoother operation.

FIG. 33c depicts an exploded view of an exemplary epicyclic gear arrangement. In general an epicyclic (“planetary”) gear arrangement comprises a single central “sun” gear, an associated plurality of “planet” gears, an arm holding each of the associated plurality of “planet” gears via a rotational bearing, and an outer “annulus” (also called “ring”) gear. In general any of the “sun” gear, associated “planet” gears, arm, or outer “annulus”/“ring” gear can serve as a rotational input, rotational output, or stationary element. A typical operational relationship is:

$$\frac{{N}_{sun}}{{N}_{ring}} = \frac{{ω}_{arm} - {ω}_{ring}}{{ω}_{sun} - {ω}_{arm}} \qquad ( 70 )$$

where the “N” variables denote the number of teeth for the subscripted gear and the “ω” variables denote the angular momentum of the subscripted element. A fixed (secured to not rotate) element would have an angular momentum “ω” variable value of zero. It can be shown that the lowest possible gear ratio (i.e., maximizing delivered torque) obtainable results from designs that fix the annulus so it does not rotate and using the “sun” gear as the input. There are other design equations known to one skilled in the art, for example the teeth-matching constraint of Nₛᵤₙ+2Nₚₗₐₙₑₜ=N_{ring}. Many embellishments also exist, such as the use of “compound planet gears” each of which comprises a two-level gear structure of differing-diameter gears. Also two or more epicyclic (“planetary”) gear arrangements can be readily cascaded. Additional epicyclic (“planetary”) gear arrangement design methods and aspects can be found, for example, in P. Lynwander's classic 1983 book Gear Drive Systems: Design and Application published by Marcel Dekker, New York, ISBN 0824718968, and in either of the 1970 or 1995 version of the Italian text by G. Henriot Gears and Planetary Gear Trains, Brevini, Reggio Emilia, Italy.

FIG. 33d depicts an example implementation wherein the electrical motor attachment depicted in FIG. 32d internally comprises at least one epicyclic (“planetary”) gear arrangement. For example, the rotating shaft of the servo-motor, stepper motor, conventional DC motor, etc. can be rotationally coupled to the “sun” gear, the “annulus”/“ring” mechanically connected to the housing of the electrical motor attachment (depicted in FIG. 32d) which is also connected (via fasteners shown in FIG. 32d) to the hollow plug body (depicted in FIG. 32a). The “arm” of the epicyclic (“planetary”) gear arrangement is then rotationally connected to the smaller cylindrical plug (depicted in FIG. 32b) or other structures such as in a next arrangement to be described below.

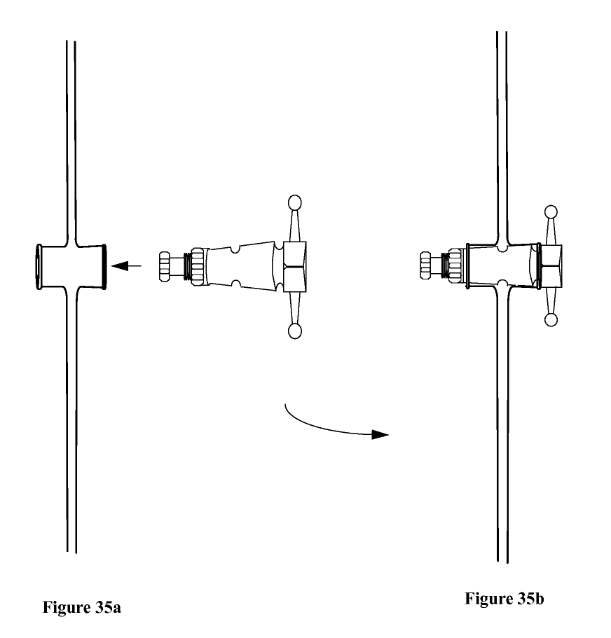

FIGS. 34a-34b illustrate a second type of stopcock flow adjustment wherein a stopcock plug internally comprises a longitudinally-movable gating element. Here, the cross-sectional area of the opening to the passageway of an otherwise traditional stopcock plug is internally modulated by a longitudinally-movable jaw. The position of the longitudinally-movable jaw is adjusted by a rotating endpiece, for example operating a screw-thread arrangement. As suggested by FIG. 34a rotating the endpiece in one angular direction closes the jaw, while rotating the endpiece in the opposite angular direction opens the jaw as suggested by FIG. 34b. FIGS. 35a-35b depict the arrangements of FIGS. 34a-34b placed into a stockcock encasement such as that depicted in FIGS. 1b and 1c.

A stopcock plug internally comprising such a longitudinally-movable gating element can be controlled by a servo or motor. The internal movable jaw can be rotationally coupled to a servo or motor and in some embodiments can be outfitted with position sensing. A traditional stopcock end-fastener can be used to hold the servo or motor controlled stopcock plug in place within the stopcock glassware encasement. Additionally, a handle can be attached to permit traditional hand-operation of the plug and/or jaw.

In an embodiment, an electrical motor attachment (such as depicted in FIG. 32d) is used to operate the longitudinally-movable gating element so as to internally modulate the cross-sectional area of the stopcock plug passageway. In an application, this arrangement can be used to control the flow through the stopcock instead of the arrangement of FIG. 32a-32g. In another application, this arrangement can be combined with the arrangement of FIG. 7a-7g so as to provide additional control of the flow through the stopcock.

In one approach, a separate electrical motor attachment is used for this purpose. In another approach, an electrical motor attachment (such as depicted in FIG. 32d) can comprise two separately controlled rotational outputs, one directed to rotating the smaller cylindrical plug (depicted in FIG. 32b) and the other for moving a longitudinally-movable gating element so as to internally modulate the cross-sectional area of the stopcock plug passageway.

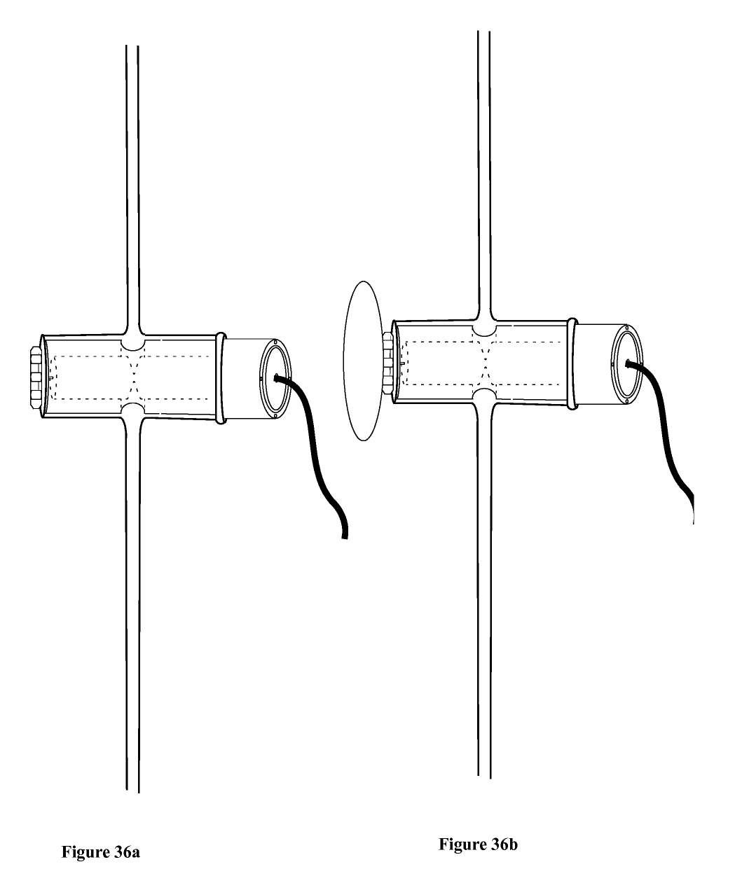

FIG. 36a shows a traditional laboratory glassware stopcock arrangement outfitted with servo or motor control for the arrangement depicted in FIG. 32g or some of the longitudinally-movable gating element arrangements described above. Additionally, a handle can be subsequently attached to permit traditional hand-operation of the stopcock; one embodiment of this is depicted in FIG. 36b. Alternatively, the handle can be of a different style, for example such as that depicted in FIG. 35b.

### Example Application in Laboratory Automation and Automated Fine Chemical Production

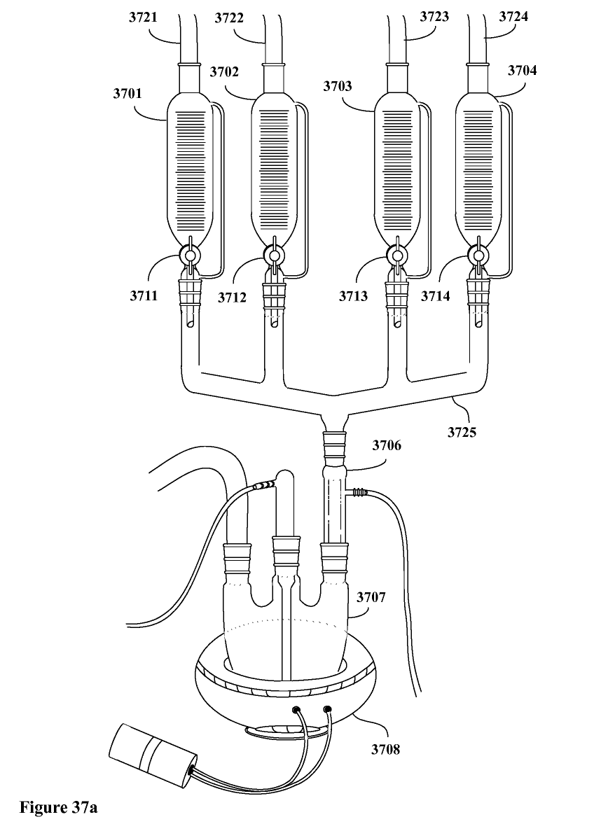

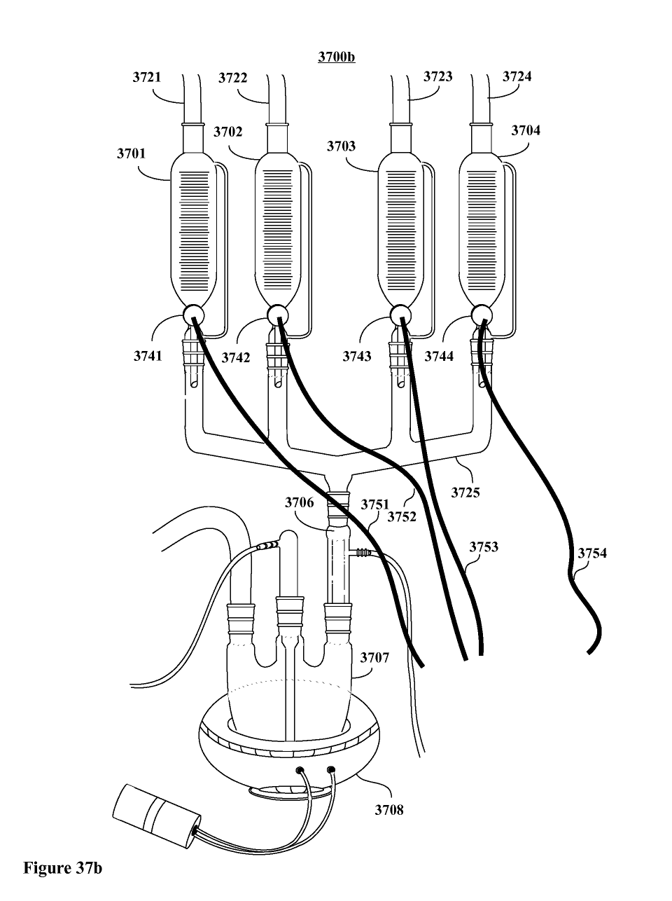

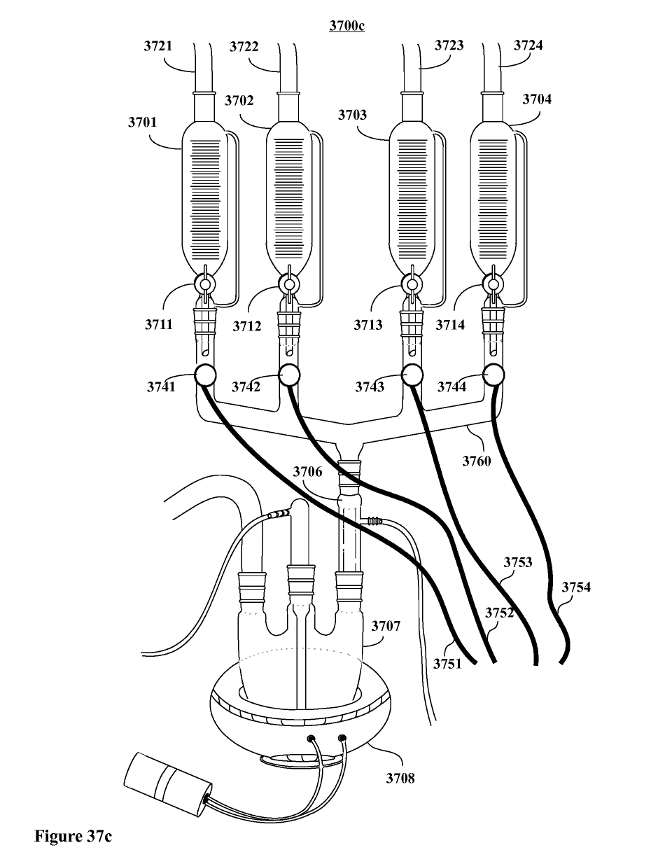

FIGS. 37a-37c depict an exemplary laboratory glassware configuration and adaptations to utilize motorized rotary valves so as to support laboratory automation. FIG. 37a depicts a hand-operated laboratory glassware configuration 3700a utilizing four traditional pressure-equalizing addition funnels 3701-3704, each connecting with a four-port downward-merge manifold, connecting via a vacuum adapter 3706 to a flask 3707 heated by a controlled electric heating mantel 3708. Each of the addition funnels 3701-3704 each include their own internal stopcock 3711-3714. In this arrangement, the four hand-operated stockcock rotary valves 3711-3714 of the addition funnels 3701-3704 are used to select alternate laboratory reagents and/or chemical species which can be held in local small reservoirs within traditional pressure-equalizing addition funnels 3701-3704. Here the vacuum adapter 3706 can be used to provide (passive or active) pressure equalization, suction, venting, etc., so as to facilitate the transfer of chemical materials from one or more selected addition funnels 3701-3704, the selection made according to the sequential or simultaneous operation of stockcock rotary valves 3711-3714. In this exemplary set-up, which may be part of a considerably larger set-up, each of the addition funnels 3701-3704 are provided with incoming chemical materials, cleaning solvents, etc. via connecting tubes 3731-3734 each of which in turn are part of or connect with other apparatus. In the figure, the connections and ports are depicted as conically-tapered ground-glass joints, but other port connection arrangements such as spherical (ball/socket), Ace-Threds® (U.S. Pat. No. 3,695,642), flange, etc.

FIG. 37b illustrates an application 3700b wherein four servo-controlled or motorized rotary valve adapters 3741-3744 are used to adapt the internal stopcock 3711-3714 in the traditional addition funnels 3701-3704. Such an arrangement is provided for by the invention and can be used in laboratory automation. Here the addition funnels 3701-3704 connect via a four-port downward-merge manifold arrangement 3760 that does not comprise stopcocks to a vacuum adapter 3706 in turn connecting to a flask 3707 heated by a controlled electric heating mantel 3708. Each of the servo-controlled or motorized rotary valve adapters 3741-3744 is used to replace the hand-operated stopcock 3711-3714 plug & handle components in the four the traditional addition funnels 3701-3704. Each of the servo-controlled or motorized rotary valve adapters 3741-3744 is connected to controlling equipment via associated small electrical cables 3751-3754.

FIG. 37c illustrates another adaptation 3700c wherein four servo-controlled or motorized rotary valve adapters 3741-3744 are used together with an inventive four-port downward-merge valve manifold 3760 taught in copending US patent application ______ to replace the four-port downward-merge manifold 3725 in the set-up 3700a of FIG. 37a. Such an arrangement is provided for by the invention and can be used in laboratory automation. Each of the servo-controlled or motorized rotary valve adapters 3741-3744 is used in place of hand-operated stopcock plug & handle components in the four hand-operated stockcock rotary valves 3731-3734 of the inventive four-port downward-merge valve manifold 3760 taught in copending US patent application ______. Each of the servo-controlled or motorized rotary valve adapters 3741-3744 is connected to controlling equipment via associated small electrical cables 3751-3754. Although the internal stopcocks 3711-3714 of the addition funnels 3701-3704 are not motorized in this set-up, it is noted they can be useful for holding materials when an addition funnel 3701-3704 is transported or for other purposes.

The resultant laboratory automation system and method may utilize existing chemical laboratory glassware and other apparatus. Additionally it may
provide interfacing existing chemical laboratory glassware with actuators and sensors for computer based process monitoring and automated process control;
provide interfacing other laboratory apparatus (heaters, stirrers, aspirators, etc.) for computer control; and
provide real-time process-control software and data recording.

The resultant laboratory automation system and method provides many valuable potential returns including but not limited to utilizing existing investment and familiarity with laboratory equipment, avoiding the waste of expensive laboratory technician time, helping to ensure process uniformity and quality control, and has application to both research and specialty chemical manufacturing.

While the invention has been described in detail with reference to disclosed embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. Therefore, the invention properly is to be construed with reference to the claims.

I claim:

1. A system for extending the adjustment range and flow control precision of the flow of materials in a rotary valve, the system comprising:
a hollow valve body comprising a at least one input port and one output port penetrating the valve body and providing couplable means to the outside of the valve body, and a rotating member deposed in and in contact with the internal surface of the chamber and the ports;
the rotating member having two elongated openings located on the surface of the rotating member and having their longer dimensions aligned on a circumference of the rotating member and positioned so that they are diagonally opposite of each other on the circumference;
a passageway through the rotating member connecting the two elongated openings thereby permitting a flow through the rotating member; and
a motor rotationally coupled to the rotating member for rotating the rotating member,
wherein the motor controls an angular position of the rotating member to position the two elongated openings of the rotating member within a first range of angular positions overlapping, at least in part, the two ports, and within a second range of angular positions wherein the two elongated opening so not overlap the two ports, and
wherein the system permits a flow of materials between the input port and the output port when the rotating member is positioned within the first range of angular positions and prevents a flow of materials between the ports when the rotating member is positioned within the second range of angular positions.

2. The system of claim 1 wherein the rotating member is a sphere.

3. The system of claim 1 wherein the rotating member is a conical plug.

4. The system of claim 1 wherein the rotating member is a cylindrical plug.

5. The system of claim 4 wherein the valve body is made of glass, and further wherein the valve body and rotating member form a laboratory glassware stopcock.

6. The system of claim 1 wherein the valve body is part of an article of laboratory glassware.

7. The system of claim 1 wherein motor is a servo.

8. The system of claim 1 wherein motor is controlled by a computer.

9. The system of claim 1 wherein the angular position of the rotating member is measured by a sensor.

10. The system of claim 1 wherein the system is controlled by laboratory automation software.
